(19) United States
(12) Patent Application Publication
(10) Pub. No.: US 2026/0251829 A1
(43) Pub. Date: Aug. 27, 2026

(54) Harmonic Gratings Utilizing Evacuated Periodic Structures

(71) Applicant: DigiLens Inc., Sunnyvale, CA (US)

(72) Inventors: Alastair John Grant, San Jose, CA (US); Richard E. Bergstrom, JR., Hayward, CA (US); Milan Momcilo Popovich, Leicester (GB)

(73) Assignee: DigiLens Inc., Sunnyvale, CA (US)

(21) Appl. No.: 18/877,194

(22) PCT Filed: Jun. 21, 2023
(86) PCT No.: PCT/US2023/068830

§ 371 Date: Dec. 19, 2024

Related U.S. Application Data
(60) Provisional application No. 63/366,734, filed on Jun. 21, 2022.

(51) Int. Cl. G02B 5/18; G01N 21/47; G01N 21/77; G03H 1/00

(52) U.S. Cl. CPC G02B 5/1857; G01N 21/4788; G01N 21/7743; G03H 1/0005

(57) ABSTRACT

Disclosed herein are harmonic gratings formed by evacuated periodic structures. In some examples, the harmonic gratings may be utilized as biosensors. Various methods of forming the biosensors include: providing a bottom substrate; coating a mixture of an inert material and a monomer onto the bottom substrate; providing a first top substrate to position the mixture between the bottom substrate and the first top substrate; applying holographic exposure to the mixture to form an intermediate periodic structure comprising polymer rich regions separated by inert material rich regions; removing the first top substrate; evacuating the inert material from the inert material rich regions leaving an evacuated periodic structure where the inert material rich regions have been replaced with air and a polymer matrix; and contacting the evacuated periodic structure with a biomaterial which interacts with the polymer matrix.

### CROSS-REFERENCED APPLICATIONS

This application claims priority to U.S. Provisional Application 63/366,734 filed on Jun. 21, 2022, the disclosure of which is incorporated by reference in its entirety.

### FIELD OF THE INVENTION

The present invention generally relates to harmonic gratings produced through evacuated periodic structures.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact head-up displays (“HUDs”) and helmet-mounted displays or head-mounted displays (HMDs) for road transport, aviation, and military applications, and sensors for biometric and laser radar (“LIDAR”) applications.

### SUMMARY OF THE INVENTION

In some aspects, the techniques described herein relate to a method for fabricating a diffractive structure, the method including: providing a bottom substrate; coating a mixture of an inert material and a monomer onto the bottom substrate; providing a first top substrate to position the mixture between the bottom substrate and the first top substrate; applying holographic exposure to the mixture to form an intermediate diffractive structure including a polymer matrix separated by inert material rich regions; removing the first top substrate; evacuating the inert material from the inert material rich regions leaving an evacuated diffractive structure where the inert material rich regions have been replaced with air; providing a second top substrate which adheres to the top surfaces of the polymer matrix; and applying mechanical force to the second top substrate while the bottom substrate remains stationary to change the profile of the evacuated diffractive structure.

In some aspects, the techniques described herein relate to a method, wherein evacuating the inert material produces a two-dimensional array of holes within a polymer matrix and extending from the bottom substrate, wherein the holes are elongated in a direction orthogonal to the bottom substrate.

In some aspects, the techniques described herein relate to a method, wherein applying holographic exposure to the mixture includes a first holographic exposure and a second holographic exposure which has a different orientation from the first holographic exposure.

In some aspects, the techniques described herein relate to a method, wherein evacuating the inert material results in a two-dimensional array of polymer elements in contact with the bottom substrate and surrounded by air, wherein the polymer elements are elongated in a direction orthogonal to the bottom substrate.

In some aspects, the techniques described herein relate to a method, wherein applying holographic exposure to the mixture includes a single holographic exposure.

In some aspects, the techniques described herein relate to a method, wherein the diffractive structure is a surface relief grating.

In some aspects, the techniques described herein relate to a method, wherein applying the mechanical force to the second top substrate includes applying pressure to the evacuated diffractive structure along a direction orthogonal to the interface between the bottom substrate and the evacuated diffractive structure.

In some aspects, the techniques described herein relate to a method, applying the mechanical force to the second top substrate includes applying a shear force to the second top substrate along a direction parallel to the interface between the bottom substrate and the evacuated diffractive structure, wherein the position of the base of the diffractive structure remains fixed relative to the bottom substrate.

In some aspects, the techniques described herein relate to a method of forming a biosensor, the method including: providing a bottom substrate; coating a mixture of an inert material and a monomer onto the bottom substrate; providing a first top substrate to position the mixture between the bottom substrate and the first top substrate; applying holographic exposure to the mixture to form an intermediate periodic structure including a polymer matrix separated by inert material rich regions; removing the first top substrate; evacuating the inert material from the inert material rich regions leaving an evacuated periodic structure where the inert material rich regions have been replaced with air within the polymer matrix; and contacting the evacuated periodic structure with a biomaterial which interacts with the polymer matrix.

In some aspects, the techniques described herein relate to a method, further including providing a second top substrate which adheres to top surfaces of the polymer matrix and applying mechanical force to the second top substrate while the bottom substrate remains stationary to change the profile of the evacuated periodic structure.

In some aspects, the techniques described herein relate to a method, wherein the evacuated periodic structure includes a two-dimensional array of holes in a polymer matrix.

In some aspects, the techniques described herein relate to a method, wherein applying the holographic exposure to the mixture includes a first holographic exposure and a second holographic exposure which has a different orientation from the first holographic exposure.

In some aspects, the techniques described herein relate to a method, wherein the evacuated periodic structure is configured to store biofluids for analysis in the holes.

In some aspects, the techniques described herein relate to a method, wherein a material having a different composition to that of the polymer matrix is backfilled into the holes.

In some aspects, the techniques described herein relate to a method, wherein the evacuated periodic structure includes a two-dimensional array of polymer elements surrounded by air.

In some aspects, the techniques described herein relate to a method, wherein the polymer matrix preferentially attaches to proteins.

In some aspects, the techniques described herein relate to a method, further including ashing the polymer matrix to remove weak polymer networks remaining.

In some aspects, the techniques described herein relate to a method, further including depositing non-reactive material on the polymer matrix after evacuating the inert material.

In some aspects, the techniques described herein relate to a method, wherein depositing the non-reactive material includes an atomic layer deposition process.

In some aspects, the techniques described herein relate to a method, further including backfilling the evacuated periodic structure with material which preferentially binds with some biological species and not others.

In some aspects, the techniques described herein relate to a method, further including coating the evacuated periodic structure with a material layer that allows the evacuated periodic structure to more effectively store proteins.

In some aspects, the techniques described herein relate to a method, further including curing the exposure mixture, wherein weak polymer networks remaining after curing act as binding points for proteins.

In some aspects, the techniques described herein relate to a method, wherein the evacuated periodic structure is doped with at least one chemical that interacts with molecules of a test sample leading to changes in the material and/or optical properties of the evacuated periodic structure.

In some aspects, the techniques described herein relate to a method, wherein the evacuated periodic structure is configured for use with light emitters to stimulate emission or scatter from molecules in a test sample contacting the evacuated periodic structure.

In some aspects, the techniques described herein relate to a biosensor, wherein the evacuated periodic structure is configured to amplify emission or scatter from molecules in a test sample contacting the evacuated periodic structure.

In some aspects, the techniques described herein relate to a biosensor, wherein the evacuated periodic structure is configured to direct emission or scatter from molecules in a test sample contacting the evacuated periodic structure to a detector.

In some aspects, the techniques described herein relate to a biosensor, wherein the evacuated periodic structure is integrated with a waveguide used to convey and direct pump radiation onto a sample material.

In some aspects, the techniques described herein relate to a biosensor, wherein the evacuated periodic structure is integrated with a waveguide used to convey emission or scatter from molecules in a test sample contacting the evacuated periodic structure to a detector.

In some aspects, the techniques described herein relate to a biosensor, wherein the evacuated periodic structure forms a host structure for materials that react with molecules to be detected.

In some aspects, the techniques described herein relate to a biosensor, wherein the evacuated periodic structure forms a host structure for materials to be analysed using material analysis by spectroscopic means.

In some aspects, the techniques described herein relate to a biosensor, wherein the evacuated periodic structure forms a host structure for materials to be subjected to chemical processing.

In some aspects, the techniques described herein relate to a biosensor, wherein the evacuated periodic structure includes gratings.

In some aspects, the techniques described herein relate to a biosensor, wherein the evacuated periodic structure includes photonic crystals.

In some aspects, the techniques described herein relate to a biosensor, wherein the evacuated periodic structure includes arrays of cylindrical cavities.

In some aspects, the techniques described herein relate to a biosensor, wherein the evacuated periodic structure is doped with material providing at least one of electrical conductivity, electrically variable birefringence, and/or piezoelectric properties.

In some aspects, the techniques described herein relate to a biosensor, wherein the evacuated periodic structure is responsive to at least one of thermal, electrical, magnetic, chemical, mechanical, and/or electromagnetic stimuli.

In some aspects, the techniques described herein relate to a biosensor, wherein the evacuated periodic structure is backfilled with materials for interacting with molecules to be detected.

In some aspects, the techniques described herein relate to a biosensor, wherein the evacuated periodic structure is formed from polymers doped with chemicals or polymers with intrinsic chemical properties.

In some aspects, the techniques described herein relate to a biosensor, wherein the evacuated periodic structure is formed from polymers with intrinsic chemical properties for detecting specific molecules.

In some aspects, the techniques described herein relate to a biosensor, wherein the evacuated periodic structure has index modulation, average index or birefringence changed by presence of molecules.

In some aspects, the techniques described herein relate to a biosensor, wherein the evacuated periodic structure is fabricated using processes involving at least one selected from the group consisting of ink jet printing, holographic lithography, mask lithography, ashing, and/or thin film coating deposition.

In some aspects, the techniques described herein relate to a biosensor, wherein the evacuated periodic structure is configured for detecting one selected from the group consisting of: gases, liquids, particulate phases, multiphase systems, or mixtures of components of more than one type of molecular structure.

In some aspects, the techniques described herein relate to a biosensor, wherein the evacuated periodic structure is integrated with polymer electronics for detection, wireless communication.

In some aspects, the techniques described herein relate to a biosensor, wherein the evacuated periodic structure is integrated in hybrid plastic/silicon electronics.

In some aspects, the techniques described herein relate to a biosensor, wherein the evacuated periodic structure is incorporated into electromechanical devices.

In some aspects, the techniques described herein relate to a biosensor, wherein the evacuated periodic structure is configured for use in one of visible, IR, millimeter wave, and/or microwave wavelength bands.

In some aspects, the techniques described herein relate to a waveguide device including: an optical substrate; a first grating with a first K-vector configured to couple light from an external source into a TIR path in the substrate; a second grating with a second K-vector; a third grating with a third K-vector; and a grating region formed by multiplexing a fourth grating with a K-vector identical to that of the second grating and a fifth grating with a K-vector identical to that of the third grating configured to provide a harmonic grating with an effective grating period different than that of the first grating, wherein at least a portion of the grating region extracts light out of the substrate towards an eyebox.

In some aspects, the techniques described herein relate to a waveguide device, configured to provide first beam diffraction at the first grating, a second beam diffraction and a first beam expansion at the second or third grating, and a third diffraction and a second beam expansion in the grating region.

In some aspects, the techniques described herein relate to a waveguide device, wherein light from the external source includes image modulated light collimated over a field of view.

In some aspects, the techniques described herein relate to a waveguide device, wherein a portion of the field of view is projected into the eyebox by a first diffraction at the first grating, a second diffraction and a first beam expansion at the second grating, and a third diffraction and a second beam expansion in the grating region, wherein a second portion of the field of view is projected into the eyebox by a first diffraction at the first grating, a second diffraction and a first beam expansion at the third grating, and a third diffraction and a second beam expansion in the grating region.

In some aspects, the techniques described herein relate to a waveguide device, wherein the eyebox overlaps the grating region.

In some aspects, the techniques described herein relate to a waveguide device, wherein K-vector closure exits between the first K-vector, the second K-vector and the third K-vector.

In some aspects, the techniques described herein relate to a waveguide device, wherein said second grating and said third grating have K-vectors symmetrically disposed about the K-vector of said first grating.

In some aspects, the techniques described herein relate to a waveguide device, wherein said fourth grating and said fifth grating have K-vectors symmetrically disposed about the K-vector of said first grating.

In some aspects, the techniques described herein relate to a waveguide device, wherein each grating includes one selected from the group consisting of a surface relief grating, a Bragg grating, or a switchable Bragg grating.

In some aspects, the techniques described herein relate to a waveguide device, wherein the harmonic grating has a K-vector substantially parallel to the K-vector of the first grating in a waveguide plane.

In some aspects, the techniques described herein relate to a waveguide device, wherein the harmonic grating has a grating period greater than that of the first grating.

In some aspects, the techniques described herein relate to a waveguide device, wherein the harmonic grating has a grating period that is exactly two times that of the first grating.

In some aspects, the techniques described herein relate to a waveguide device, wherein harmonic grating has a grating period smaller than that of the first grating.

In some aspects, the techniques described herein relate to a waveguide device, wherein the grating region is formed by multiplexing orthogonal gratings having intersection nodes at corners of a repeating rectangle with a long dimension of the rectangle parallel to the K-vector of the harmonic grating.

In some aspects, the techniques described herein relate to a waveguide device, wherein the grating region is formed by multiplexing orthogonal gratings having intersection nodes at corners of a repeating rectangle with a short dimension of the rectangle parallel to the K-vector of the harmonic grating.

In some aspects, the techniques described herein relate to a waveguide device, wherein the grating region is formed using a master including spatially displaced gratings with orthogonal K-vectors.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1A conceptually illustrates in a plan view a waveguide display employing an input grating and multiplexed fold gratings for providing beam expansion and extraction gratings in accordance with many embodiments.

FIG. 1B conceptually illustrates a waveguide side elevation view of a waveguide based on the one of FIG. 1A in accordance with many embodiments.

FIG. 1C is a first diagrammatic representation of the K vector closure condition for the gratings employed in the display of FIG. 1A in accordance with many embodiments.

FIG. 1D is a second diagrammatic representation of the K vector closure conditions for the gratings employed in the display of FIG. 1A in accordance with many embodiments.

FIG. 2 conceptually illustrates in a plan view a waveguide display employing an input grating and multiplexed fold gratings for providing beam expansion and extraction gratings showing beam paths from central and peripheral input pupils in accordance with many embodiments.

FIG. 3 conceptually illustrates the formation of harmonic gratings and grating intersection nodes by a multiplexed pair of gratings with opposing clock angles in accordance with many embodiments.

FIG. 4A is an example method for producing a polymer periodic structure in accordance with an embodiment of the invention.

FIGS. 4B-1 to 4B-4 illustrate a process for fabrication of the polymer periodic structure described in connection with FIG. 4A.

FIG. 5 conceptually illustrates the formation of harmonic gratings by a multiplexed pair of gratings with opposing clock angles in accordance with many embodiments.

FIG. 6A conceptually illustrates in a plan view a waveguide display employing an input grating and multiplexed fold gratings for providing beam expansion and extraction gratings showing beam paths from a central input pupils in accordance with many embodiments.

FIG. 6B conceptually illustrates a waveguide side elevation view of a waveguide based on the one of FIG. 6A in accordance with many embodiments.

FIG. 7 conceptually illustrates two gratings with opposing clock angles in accordance with many embodiments.

FIG. 8 conceptually illustrates two gratings with opposing clock angles showing their intersection nodes in accordance with many embodiments.

FIG. 9 conceptually illustrates two gratings with opposing clock angles showing the intersection nodes that contribute to a harmonic grating of spatial frequency lower than that of the input grating in accordance with many embodiments.

FIG. 10 conceptually illustrate the formation of a multiplexed grating using orthogonal gratings with grating intersection nodes defined by a repeating square cell in accordance with many embodiments.

FIG. 11 conceptually illustrate the formation of a multiplexed grating using orthogonal gratings with grating intersection nodes defined by a repeating square cell and also illustrating the formation of unwanted gratings in accordance with many embodiments.

FIG. 12 conceptually illustrate the formation of a multiplexed grating using orthogonal gratings with grating intersection nodes defined by a repeating rectangular cell in accordance with many embodiments.

FIG. 13 illustrates the key grating relationships relevant to the analysis of harmonic gratings.

FIG. 14A conceptually illustrates a plan view of a mastering setup in accordance with many embodiments.

FIG. 14B is a first cross section view of the mastering setup of FIG. 14A in accordance with many embodiments.

FIG. 14C is a second cross section view orthogonal to the first cross view of FIG. 14B in accordance with many embodiments.

FIG. 15 illustrates an example scanning electron microscope (SEM) image of a manufactured multiplexed EPS in accordance with an embodiment of the invention.

FIGS. 16A and 16B illustrate various embodiments of a biosensor including a dopant.

FIG. 17A is a cross section of an embodiment of a biosensor including a waveguide, a laser source, and input coupling module in accordance with an embodiment of the invention.

FIG. 17B is a cross section of an embodiment of a biosensor including a waveguide, a laser source, and input coupling module in accordance with an embodiment of the invention.

FIG. 17C is a cross section of an embodiment of a biosensor in accordance with an embodiment of the invention.

FIG. 18 schematically illustrates examples of pillars in accordance with an embodiment of the invention.

FIG. 19 schematically illustrates an EPS structure in accordance with an embodiment of the invention.

FIG. 20 illustrates the EPS structure of FIG. 19 with a backfill material.

FIG. 21 illustrates the EPS structure of FIG. 20 with a cover substrate.

FIG. 22 illustrates the EPS structure of FIG. 21 after a shear force is applied to the cover substrate.

FIG. 23 illustrates applying a cover substrate and backfill material to a tapered grating.

FIG. 24A illustrates applying a shear force to the tapered grating of FIG. 23.

FIG. 24B illustrates a bent tapered grating after the shear force of FIG. 24A.

FIG. 25 illustrates applying a shear force while applying a down force to the grating.

### DETAILED DESCRIPTION

The present disclosure relates to holographic waveguides and more particularly to multiplexed gratings for used in waveguide displays.

Holographic waveguide technology may enable low cost, efficient and versatile diffractive optical solutions for many applications. Waveguide grating architectures using multiplexed folds offer many advantages include space saving compared with traditional input fold and output grating architectures and large field of view at lower substrate index as a result of only half the field of view being addressed by each of the multiplexed folds.

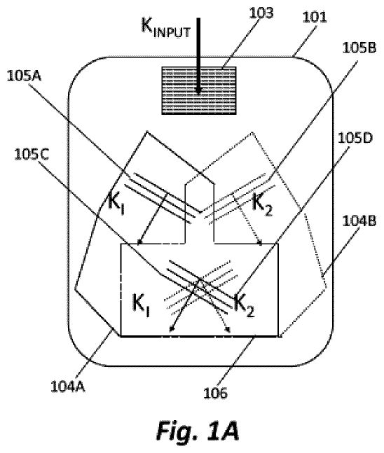

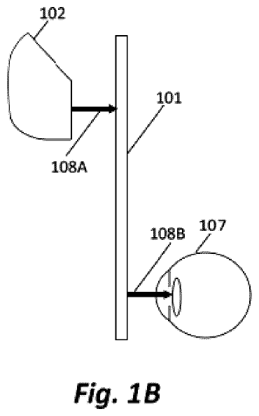

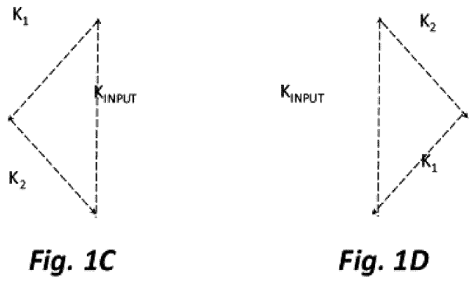

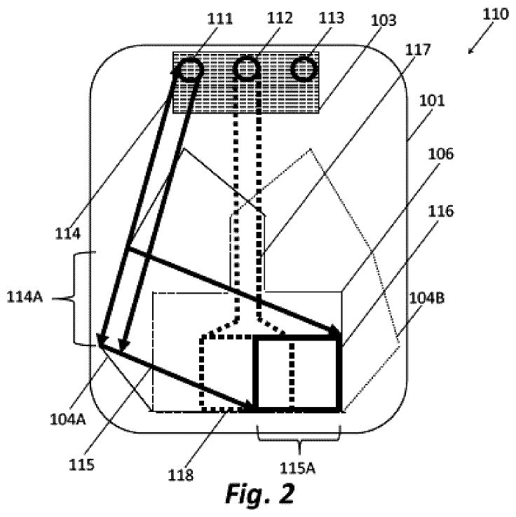

One such waveguide grating architecture, referred to as an integrated dual expansion (IDA) waveguide. FIG. 1A illustrates a plan view of an example IDA waveguide. The IDA waveguide includes a waveguide substrate 101 supporting an input grating 103 with K vector K_{INPUT} and multiplexed fold gratings 104A, 104B contain gratings with K-vectors K₁, K₂. The gratings are configured to provide a first beam expansion and beam directional change in each of first region 105A and second region 105B corresponding to non-multiplexed portions of the grating. The gratings portions 105C, 105D lying in the multiplexed region 106 are configured to provide a second beam expansion and extraction from the substrate towards an eyebox which overlap the extraction region. Examples of IDA waveguides are described in U.S. Pat. App. No. 2020/0264378, entitled “Methods and Apparatuses for Providing a Holographic Waveguide Display Using Integrated Gratings” and filed on Feb. 18, 2020, which is incorporated by reference in its entirety for all purposes. The multiplexed region 106 may include a harmonic grating which includes an effective grating period different from the input grating 103.

FIG. 1B shows a periscope configuration of the waveguide architecture of FIG. 1A, with light input and output taking pace on opposite sides of the waveguide in accordance with many embodiments. In other embodiments, the input and extraction may take place on the same side of the waveguide. As illustrated in FIG. 1B, image light 108A from an input image generator 102 is projected over a field of view and coupled into a TIR path in the substrate by the input grating and extracted image light 108B directed toward a display viewer's eye 107. The image light is divided into a first field of view portion which propagates towards the eyebox via a first diffraction at the first fold grating region 105A and a second diffraction at the multiplexed region 106 and a second field of view portion which propagates towards the eyebox via a first diffraction at the second fold grating region 105A and a second diffraction at the multiplexed region 106.

FIG. 1C and FIG. 1D illustrate the grating vector closure conditions applying to the first and second field of view propagation in the embodiment of FIGS. 1A-1B. The modulus of a grating vector is equal to 2π/Λ where Λ is the grating period.

It has been discovered that manufacturing the multiplexed portion of the two fold gratings in the extraction region 106 leads to the formation of a harmonic grating. In many embodiments, the harmonic grating may have the same period as the input grating which may lead to direct outcoupling of image light to the eye. In other words, two interactions (with the input grating and the multiplexed extraction region) are experienced from in coupling to extraction, resulting in single axis pupil expansion rather than the expected three interactions (with the input grating, the fold non-multiplexed region and the multiplexed extraction region) resulting in dual axis pupil expansion that occur for other light paths from the input coupler to the eyebox. The harmonic grating may reduce the number of grating interactions which may add efficiency. However, the harmonic grating may have lower diffraction efficiency and may lead to an unwanted bright vertical band in the viewed image. The apparent location in the field of view of this vertical band depends on the eye pupil position relative to the pupil.

An efficient solution for overcoming unwanted light extraction from multiplexed fold grating in integrated dual axis expansion waveguides may be advantageous. Thus, in some cases, it may be advantageous to mitigate the manufacture of the harmonic grating. Various embodiments of the invention relate to mitigating the harmonic grating which is created through the manufacturing of the multiplexed grating.

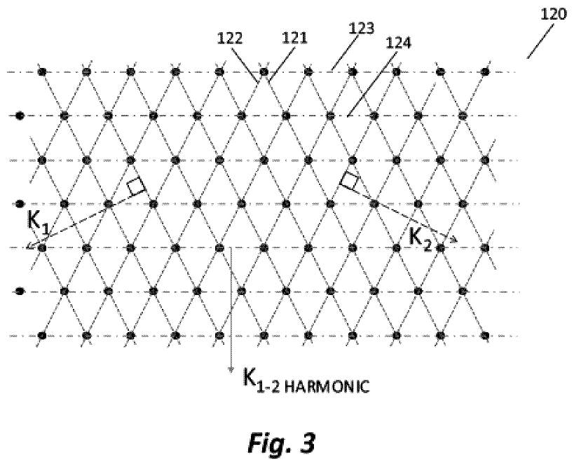

FIG. 2 is a plan view of a waveguide 110 formed by multiplexing two fold gratings 104A, 104B similar to the ones of FIGS. 1A and 1B in accordance with an embodiment of the invention. The input pupils 111-113, input grating 103, and left and right fold gratings 104A, 104B forming a multiplexed grating region 106. A first ray path 114 starting at a pupil 111 near an extremity of the input grating undergoes three grating interactions e.g., image light in-coupled at the input grating 103, undergoes a first expansion 114A a beam turning 115 and extraction and a second expansion 115A from the extraction region 116 towards an eyebox. A second ray path 117 starting at the pupil 112 near the center of the input grating undergoes two grating interactions e.g., image light in-coupled at the input grating 103 propagates directly to the portion 118 of the extraction region 118 thus undergoing beam expansion in just one direction. The bright streak formed by the second ray path depends on the eye position in relation to the input projector. In the illustrated embodiment the propagation path from the top to the bottom and the streak is nominally vertical and rotates about the input pupil position as the eye mover from left to right within the eyebox.

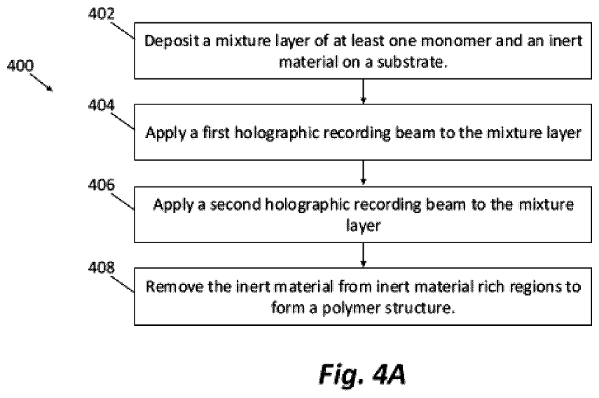

FIG. 3 illustrates an example of how harmonic gratings occur with reference to the formation of nodes within the multiplexed grating 120 from two gratings 121, 122 with k-vectors labelled by K₁ and K₂. A portion of the harmonic grating may be represented by the horizontal (dot-dash) lines (123, 124).

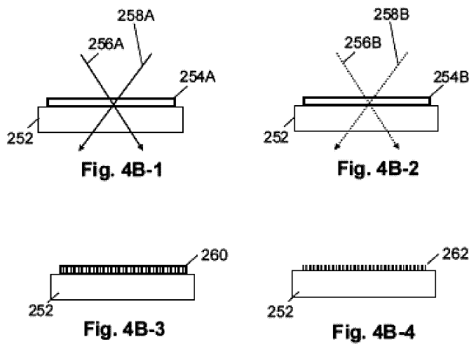

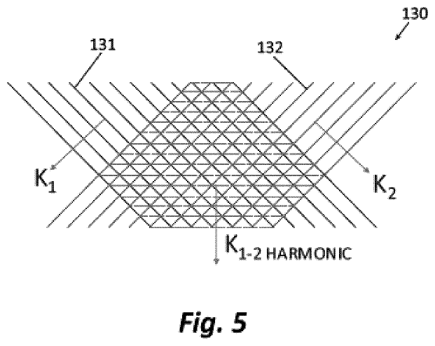

FIG. 4A is an example method for producing a polymer periodic structure in accordance with an embodiment of the invention. Referring to the flow diagram, the method 400 includes depositing (402) a mixture layer of at least one monomer and an inert material on a substrate. The at least one monomer may include an isocyanate-acrylate monomer or thiolene. For example, the mixture may include a liquid crystal and a thiolene based photopolymer. In some embodiments, the mixture may include a liquid crystal and an acrylate-based photopolymer. In some embodiments, the at least one liquid crystal may be a full liquid crystal mixture or may be a liquid crystal single which may include only a portion of the liquid crystal mixture such as a single component of the liquid crystal mixture. In some embodiments, the at least one liquid crystal may be substituted for a solution which phase separates with the monomer during exposure. The criteria for such a solution may include ability to phase separate with the monomer during exposure, ease of removal after curing and during washing, and ease of handing. Example substitute solutions include solvents, non-reactive monomers, inorganics, and nanoparticles.

Depositing the mixture of the monomer and the liquid crystal may also include mixing one or more of the following with the at least one monomer and the liquid crystal: initiators such as photoinitiators or coinitiators, multifunctional thiol, dye, adhesion promoters, surfactants, and/or additional additives such as other cross linking agents. This mixture may be allowed to rest in order to allow the coinitiator to catalyze a reaction between the monomer and the thiol. The rest period may occur in a dark space or a space with red light (e.g. infrared light) at a cold temperature (e.g. 20° C.) for a period of approximately 8 hours. After resting, additional monomers may be mixed into the monomer. This mixture may be then strained or filtered through a filter with a small pore size (e.g. 0.45 μm pore size). After straining, this mixture may be stored at room temperature in a dark space or a space with red light before coating.

The substrate may be a transparent substrate. In certain embodiments, the transparent substrate may be a glass substrate or a plastic substrate. In some embodiments, the transparent substrate may be a flexible substrate to facilitate roll to roll processing. In some embodiments, the EPS may be manufactured on a flexible substrate through a roll to roll process and then peeled off and adhered to a rigid substrate. In some embodiments, the multiplexed grating may be manufactured on a flexible substrate and a second flexible release layer may be peeled off and discarded which would leave the EPS on a flexible layer. The flexible layer may be then bonded to another rigid substrate.

The layer of mixture may be deposited using inkjet printing. In some embodiments, the mixture is sandwiched between the substrate and another substrate using glass spacers to maintain internal dimensions. A non-stick coating may be applied to the other substrate before the mixture is sandwiched. The non-stick coating may include a fluoropolymer such as OPTOOL UD509 (produced by Daikin Chemicals), Dow Corning 2634, Fluoropel (produced by Cytonix), and EC200 (produced by PPG Industries, Inc).

The method 400 further includes applying (404) a first holographic recording beam to the mixture layer. Holographic recording beams may be a two-beam interference pattern which may cause phase separation of the LC and the polymer. In response to the holographic recording beam, the liquid monomer changes to a solid polymer whereas the neutral, inert non-reactive substance (e.g. LC) diffuses during holographic exposure in response to a change in chemical potential driven by polymerization. While LC may be one implementation of the neutral, non-reactive substance, other substances may also be used. The substance and the monomer may form a miscible mixture prior to the holographic exposure and become immiscible upon holographic exposure.

The method 400 further includes applying (406) a second holographic recording beam to the mixture layer. The second holographic recording beam may be similar to the first holographic beam except with a different orientation or k-vector. It has been discovered that applying the first holographic recording beam and the second holographic recording beam creates a periodic dot pattern grating within the mixture layer where the dots are inert material rich regions which are surrounded by polymer regions. In some embodiments, the first holographic beam and the second holographic beam may have orthogonal orientations or k-vectors.

After applying the holographic recording beams, the mixture may be cured. The curing process may include leaving the mixture under low-intensity white light for a period of time until the mixture fully cures. The low intensity white light may also cause a photo-bleach dye process to occur. Thus, a HPDLC periodic structure having alternating polymer rich and inert material rich regions can be formed. In some embodiments, the curing process may occur in two hours or less. After curing, one of the substrates may be removed exposing the HPDLC periodic structure. Advantageously, the non-stick coating may allow the other substrate to be removed while the HPDLC periodic structure remaining.

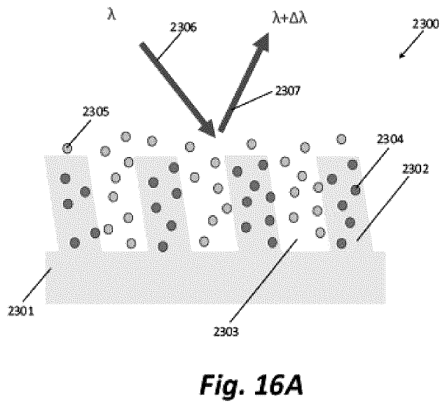

HPDLC periodic structure may include alternating sections of inert fluid rich regions and polymer regions. The inert fluid in the inert fluid rich regions can be removed (408) to form polymer surface relief gratings (SRGs) or evacuated periodic structures (EPSs) which may be used as deep SRGs. This is illustrated in described below. However, the polymer structures may also be utilized for various other application such as biological applications. It has been discovered that after removal of the inert fluid, the remaining polymer structure may form a periodic hole structure which forms in a grid structure. An example image of this periodic hole structure is illustrated in FIG. 15. As illustrated, the periodic hole structure may be a two-dimensional array of holes in a polymer matrix.

The periodic hole structure may be an air structure. The inert fluid may be removed by gently immersing the HPDLC periodic structure into a solvent such as IPA. The IPA may be chilled and may be kept at a temperature lower than room temperature while the grating is immersed in the IPA. The periodic structure may be then removed from the solvent and dried. In some embodiments, the periodic structure is dried using a high flow air source such as compressed air. After the inert fluid is removed from the periodic structure, a polymer periodic structure is formed. The polymer periodic structure may be a polymer-air surface relief grating is formed.

An additional ashing step described throughout may be performed in order to t remove remaining weakened polymer networks to improve the hole definition. In some embodiments, an additional ALD step may be utilized to deposit an overcoat layer on the formed polymer periodic structure.

FIGS. 4B-1 to 4B-4 illustrate a process for fabrication of the polymer periodic structure described in connection with FIG. 4A. FIG. 4B-1 illustrates a mixture 254A of monomer and inert material deposited on a transparent substrate 252 which is exposed to a first set of holographic recording beams 256A, 258A. This step corresponds to step 404 of FIG. 4A. The holographic exposure beams 256A, 258A may be deep UV beams. In some examples, the mixture 254A may also include at least one of a photoinitiator, a coinitiator, a multifunctional thiol, adhesion promoter, surfactant, and/or additional additives.

The mixture 254A may include nanoparticles. The mixture 254A may include photoacids. The mixture 254A may be a monomer diluted with a non-reactive polymer. The mixture 254A may include more than one monomer. In some embodiments, the monomer may be isocyanate-acrylate based or thiolene based. In some embodiments, the inert material may be a liquid crystal which may be a full liquid crystal mixture or a liquid crystal single. A liquid crystal single may only include a portion of a full liquid crystal mixture. Various examples, liquid crystal singles may include one or all of cyanobiphenyls, alkyl, alkoxy, cyanobiphenyls, and/or terphenyls. The liquid crystal mixture may be a cholesteric liquid crystal. The liquid crystal mixture may include chiral dopants which may control the grating period. The liquid crystal mixture may include photo-responsive and/or halogen bonded liquid crystals. In some embodiments, liquid crystal may be replaced with another substance that phase separates with the monomer during exposure to create polymer rich regions and substance rich regions. Advantageously, the substance and liquid crystal singles may be a cost-effective substitute to full liquid crystal mixtures which are removed at a later step as described below.

In some embodiments, the liquid crystal in the mixture 254A may have a different between an extraordinary refractive index and an ordinary refractive index of less than 0.01. In some embodiments, the liquid crystal in the mixture 254A may have a different between an extraordinary refractive index and an ordinary refractive index of less than 0.025. In some embodiments, the liquid crystal in the mixture 254A may have a different between an extraordinary refractive index and an ordinary refractive index of less than 0.05.

FIG. 4B-2 illustrates the previously exposed mixture 254B of monomer and inert material deposited on a transparent substrate 252 which is exposed to a second set of holographic recording beams 256B, 258B. This step corresponds to step 406 of FIG. 4A. The second set of holographic recording beams 256B, 258B may be similar to the first holographic beam 256A, 258A except with a different orientation or k-vector. In some embodiments, the first set of holographic recording beam 256A, 258A and the second holographic recording beam 256B, 258B may have orthogonal orientations or k-vectors.

the first set of holographic recording beam 256A, 258A and the second holographic recording beam 256B, 258B may transform the monomer into a polymer in some areas. the first set of holographic recording beam 256A, 258A and the second holographic recording beam 256B, 258B may include intersecting recording beams and include alternating bright and dark illumination regions. A polymerization-driven diffusion process may cause the diffusion of monomers and inert material in opposite directions, with the monomers undergoing gelation to form polymer-rich regions (in the bright regions) and the inert material becoming trapped in a polymer matrix to form inert material rich regions (in the dark regions).

FIG. 4B-3 illustrates the resultant polymer periodic structure 260 formed after the exposures of FIGS. 4B-1 and 4B-2 which may form an intermediate periodic structure. It has been discovered that applying the first set of holographic recording beam 256A, 258A and the second holographic recording beam 256B, 258B creates a periodic dot pattern grating within the mixture layer where the dots are inert material rich regions which are surrounded by polymer regions.

FIG. 4B-4 illustrates the polymer periodic structure 262 after the inert material has been removed. The polymer periodic structure 262 includes a periodic dot pattern where the dots are air pockets which are surrounded by polymer regions. Advantageously, polymer periodic structure 262 may include a large depth with a comparatively small period in order to form a deep structure. The inert material may be removed by washing with a solvent such as isopropyl alcohol (IPA). The solvent may be strong enough to wash away the inert material but weak enough to maintain the polymer. In some embodiments, the solvent may be chilled below room temperature before washing the grating. As discussed above, the polymer periodic structure may form EPSs. These EPSs may be utilized as multiplexed gratings.

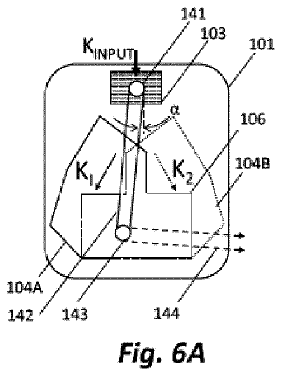

FIG. 5 conceptually illustrates the formation of a multiplexed grating 130 from intersecting gratings 131, 132 with K-vectors K₁ and K₂ forming the harmonic fringes with K-vector K_{1-2 HARMONIC}. The multiplexed grating 130 may be formed with the holographic recording beam described in connection with FIG. 4. Referring also to the K-vector diagrams described in connection with FIGS. 1C-1D, it should be apparent that where Kᵢₙₚᵤₜ+K₁+K₂=0, then the equation Kᵢₙₚᵤₜ+K_{1-2 HARMONIC}=0 also holds. As already noted, this may lead to direct outcoupling of image light to the eye which may be disadvantageous. The K vectors K₁ and K₂ may be orthogonal.

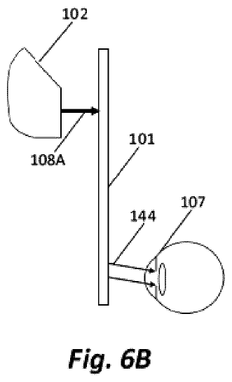

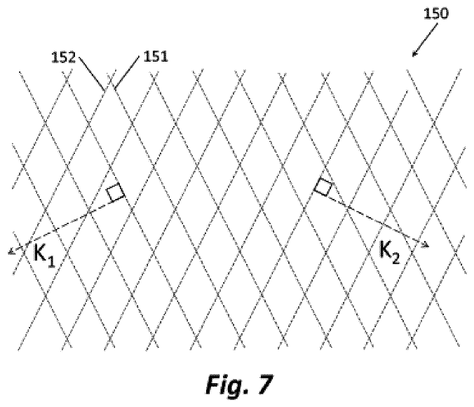

FIG. 6A is a plan view of the waveguide 101 showing an image light path undergoing substantially direct outcoupling of light, that is, only two grating interactions taking place compared to the three interactions that take place for other optical paths between the input and eyebox. The light path includes in-coupling into the substrate via an input pupil 141, propagating in the direction 142 (at an angle α which may be measured relative to vertical axis of the substrate in the plane of the drawing) and beam grating interaction 143 in the multiplexed extraction region 106 and extraction into an output beam 144 towards the eyebox, where the output beam is out of the plane of the drawing. Not the as the angle α increases from zero the degree of interaction of the image light with the non-multiplexed regions of gratings 104A, 104B will increase. FIG. 6B conceptually illustrates a cross section view of the waveguide 101 showing the extracted image light 144.

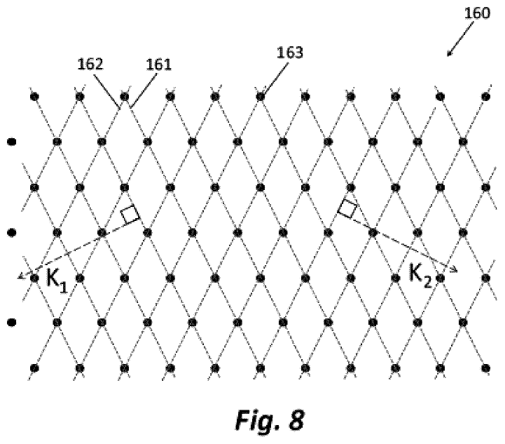

FIG. 7 conceptually illustrates the formation of a multiplexed grating 150 from two gratings 151,152 with k-vectors labelled by K₁ and K₂ in accordance with many embodiments.

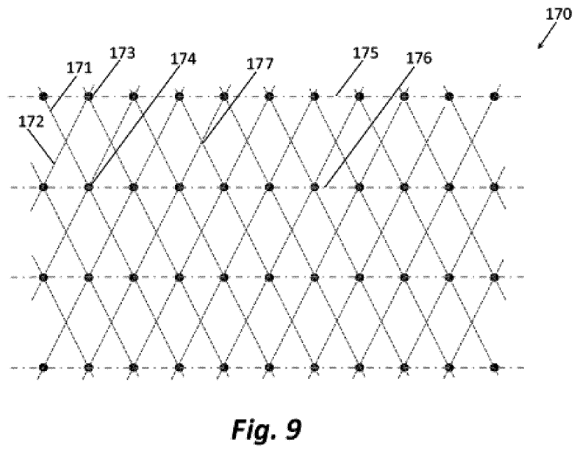

According to the usual convention, the K vectors are defined as being aligned at right angles to the grating fringe planes. FIG. 8 conceptually illustrates the formation of nodes within a multiplexed grating 160 from two gratings 161, 162 with k-vectors labelled by K₁ and K₂ in accordance with many embodiments. The periodicity of nodes 163 of the two gratings 161, 162 leads to the formation of harmonic gratings as shown in FIG. 8.

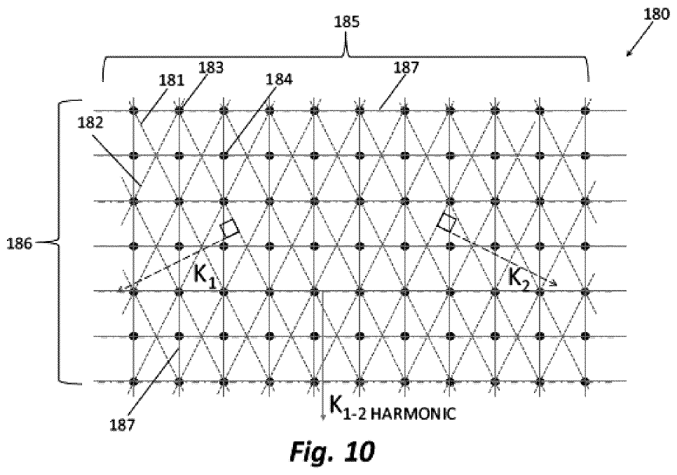

FIG. 9 illustrates the formation of nodes within the multiplexed grating 170 formed from the two gratings 171, 172 in accordance with many embodiments. In some embodiments, the spatial frequency of the harmonic grating is reduced, such that there is no direct two grating coupling path from the input coupler with K-vector K_{INPUT} to the eyebox with K-vector K_{1-2 HARMONIC}. In some embodiments, rows of desired nodes 175, 176 may be retained while eliminating the formation of intervening rows of unwanted nodes 177. Such a configuration results in a larger harmonic grating period, as shown in FIG. 9, which reduces the K-vector modulus by a factor of two. The increased harmonic grating period also reduces the diffraction efficiency of the harmonic grating.

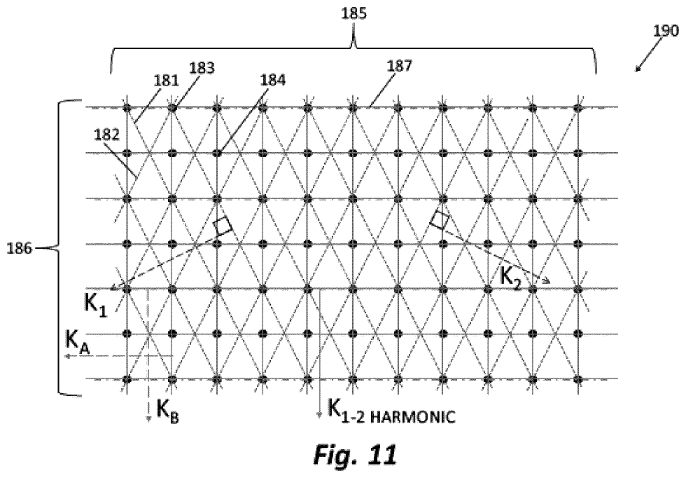

FIG. 10 conceptually illustrates the formation of a square node grid 180 using two orthogonally aligned gratings 185, 186. The nodes 183, 184 correspond to the intersection points of the orthogonal gratings. The harmonic gratings are represented by the horizontal 187 and diagonal 181, 182 dash lines with K-vectors K₁ and K₂ forming the unwanted harmonic grating with K-vector K_{1-2 HARMONIC}.

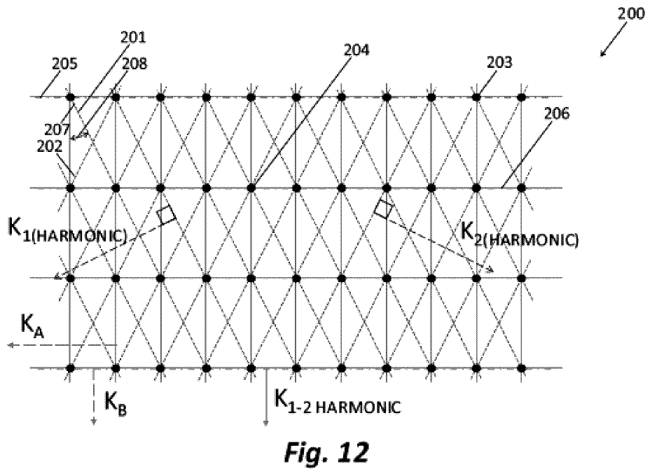

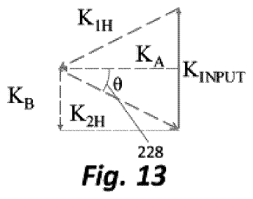

FIG. 11 shows the harmonic gratings of FIG. 9 in more detail. The grating may include the orthogonal gratings having K-vectors K_{A} and K_{B} which have equal magnitudes. In many embodiments, the gratings 185, 186 may be orthogonal as shown in FIG. 11. In some embodiment, the gratings 185, 186 may not be orthogonality. As illustrated, the harmonic gratings include gratings having the desired K₁ and K₂ K-vectors. However, the harmonic gratings also include the unwanted K_{B} K-vector grating, which is identical to the unwanted K_{1-2 Harmonic} grating. Better control of harmonic gratings may be achieved by using a rectangular node grid instead of the square node grid illustrated in FIG. 12.

In many embodiments, the multiplexed grating region may be formed by multiplexing orthogonal gratings having intersection nodes at corners of a repeating rectangle with the long dimension of the rectangle parallel to the K-vector of the harmonic grating. FIG. 12 conceptually illustrates a rectangular node grid 200 formed using two orthogonal gratings with grating vectors K_{A} and K_{B}. The node grid may have rectangular node patterns of various aspect ratios according to various embodiments. The clock angle 208 is given by the equation θ=tan₋₁ (K_{A}/K_{B}). In many embodiments, such as the one shown in FIG. 12, the modulus of grating K_{A} is two times the modulus of grating vector 2K_{B}. In many embodiments, the gratings are not orthogonal. The harmonics include the desired K_{1 HARMONIC} and K_{2 HARMONIC} K-vector gratings and the unwanted K_{B} K-vector grating, which is identical to the unwanted K_{1-2HARMONIC} grating. However, the latter now has a longer harmonic grating period and so will not match the K-vector of the input grating to enable direct input grating to harmonic grating path that will form an unwanted bright band in the field of view as discussed above. Note that since K_{INPUT} is also 2K_{1-2 HARMONIC}, the K-vector sum condition discussed above (e.g., K_{INPUT}+K_{1-2 HARMONIC}=0 is not satisfied).

As discussed above, the ratio of the moduli of grating vectors K_{A} and K_{B} determines the clock angle of the harmonic gratings. The clock angle is given by θ=tan⁻¹ (K_{A}/K_{B}), for the orthogonal node case, where the clock angle is relative to the vertical direction (as shown in FIG. 12). The clock angles for non-orthogonal node grids can be calculated directly from the node geometry. It should be noted that the grating configurations illustrated in the drawings and discussed above only highlight the first order harmonic gratings e.g., the harmonic gratings defined by the grating vectors K_{A} and K_{B}. It should be noted that all nodes may form harmonic gratings. However, in many embodiments, the diffraction efficiency of those higher order harmonic gratings decreases due to the increased node spacing. Slant angle in the copy can also be used. The harmonic generated will have a slanted node, the slant angle of which is dependent on the exposure beams. The clock and slant angles apply to VBG (Volume Bragg Grating) formation, and to EPSs (Evacuated Periodic Structures). Examples of various manufacturing processes and structures for VBGs and EPSs are disclosed in U.S. Pat. No. 11,442,222, entitled “Evacuated gratings and methods of manufacturing ” and filed Aug. 28, 2020, which is hereby incorporated by reference in its entirety for all purposes.

In many embodiments, the multiplexed grating region may be formed using a master comprising spatially displaced gratings with orthogonal K-vectors.

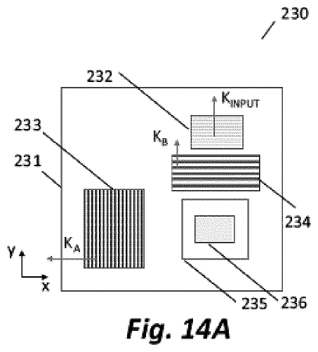

FIG. 13 illustrates the key grating relationships relevant to the analysis of harmonic gratings. The clock angle 208 may be defined by θ=tan⁻¹ (K_{A}/K_{B}) and the grating vectors may be defined using the equations: K_{INPUT}=2K_{B}=2K_{A} tan (θ), where K_{A}=K_{H} cos(θ) and K_{B}=K_{H} sin(θ). In the case where K_{INPUT}=K_{A}, then θ=tan⁻¹(½)=26.57°.

The various grating embodiments discussed above may be implemented using various grating types including and not limited to surface relief gratings (including deep surface relief gratings with grating thinness greater that the grating period), Bragg gratings and switchable Bragg gratings.

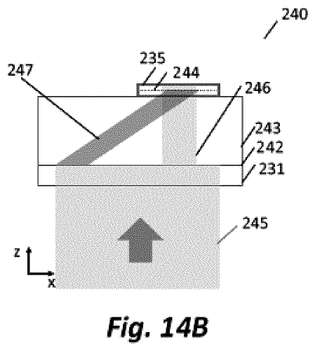

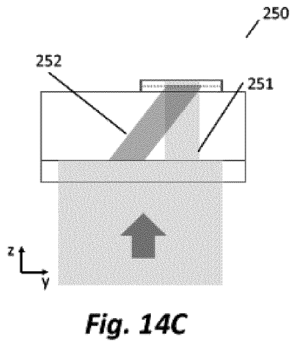

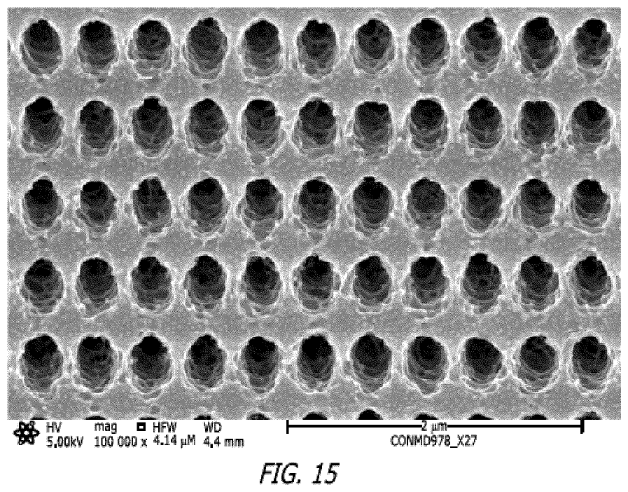

A variety of master configurations may be used to fabricate the multiplexed gratings discussed above. In many embodiments, the grating vectors K_{A} and K_{B} are orthogonal. In many embodiments the grating vectors may be aligned relative to principal axes of the master substrates. In many embodiments e-beam mastering can be used to fabricate the master. In many embodiments the master plate may include an input grating. Optical transmission of the zero order can be controlled with a partially transmitting region for the zero-order reaching the copy plane. The zero order beams of the K_{A} and K_{B} prescriptions are best as being different beams (so polarization on exposure is optimized). The exposure beam angles can be changed to different angles depending on the grating slant angles required. In many embodiments, the orthogonal gratings may be contact copied gratings formed in a photopolymer material system comprising at least two selected from the group of a monomer, a liquid crystal and a nanoparticle. FIG. 14A conceptually illustrates a plan view 230 of a mastering setup in accordance with many embodiments. FIG. 14B is a first cross section view 240 in accordance with many embodiments. FIG. 14C is a second cross section view orthogonal to the first cross view in accordance with many embodiments. FIGS. 14A-14C provide YX, ZX and ZY projections respectively in a Cartesian XYZ reference frame. Each cross-section view illustrates a master substrate, a master chrome layer, a glass spacer block, the copy grating cell and the copy plane and the incident beam. FIG. 14B shows the 0-order K_{A} beam and the diffract order K_{A} beam. FIG. 14C shows the 0-order K_{B} beam and the diffract order K_{B} beam. FIG. 14B does not show the K_{B} beam or the K_{INPUT} beam. FIG. 14C does not show the K_{A} beam or the K_{INPUT} beam.

As shown in FIG. 14A the master may include a master substrate 231, an input grating 232 with k-vector K_{INPUT}, a first grating 233 and a second grating 234 with the orthogonal K-vectors K_{A} and K_{B} and a copy grating cell 235. A multiplexed grating may be formed in the copy grating cell as discussed above. FIG. 14B shows the master substrate 231 master chrome layer 242, glass spacer block 243. The copy plane 244 is illuminated crossed interring beams provided by illuminating the master with an input beam 245 with provides the zero order (K_{A}) beam 246 and the diffracted order (K_{A}) beam 247. FIG. 14C shows the zero order (K_{B}) beam 251 and the diffracted order (K_{B}) beam 252.

FIG. 15 illustrates an example of a scanning electron microscope (SEM) image of a manufactured periodic hole structure which is manufactured through the process described in connection with FIG. 4A and FIGS. 4B-1 through 4B-4. in accordance with an embodiment of the invention. As illustrated, the manufactured multiplexed EPS may include periodic holes in a grid. The holes may result from the formation of harmonic gratings of the types discussed above. The periodic hole structure may also be used for various applications such as biological applications. The holes may include various slant angles. The direction of the cylindrical holes at any direction vertically and horizontally can be controlled based on the exposure technique. The period and the size of the holes can be controlled based on the exposure technique and/or the formulation of the starting holographic mixture. The cross-section shape of the holes can be controlled by the exposure technique for example the hole shape may depend on the recording beam intensity profiles. In some embodiments, the holes may result from a photonic crystal recording set up in which more than two recording beams are present. In some embodiments, after holographic exposure, the inert fluid material may be washed out of the structures to form a periodic hole structure of air embedded in a polymer matrix. In some embodiments, after formation of the holes, an ashing process may be performed to remove remaining weakened polymer networks to improve the grating definition. The ashing stage may also be used to fine-tune the cross-sectional shape of the holes. Spatial variation of hole area cross section geometry. In some embodiments, a backfilling technique may be performed to fill the holes with a backfill material to create a hybrid structure or hybrid grating. In many embodiments, the hybrid structure may be partially backfilled such that it combines the functions of a volume grating and a surface relief grating, providing a hybrid grating. In some embodiments, the hybrid grating may be completely backfilled such that it functions as a volume grating. Examples of backfill materials are described in U.S. Pat. No. 11,442,222, entitled “Evacuated gratings and methods of manufacturing” and filed Aug. 28, 2020, which is hereby incorporated by reference in its entirety for all purposes. The holes may be a two-dimensional array of holes within a polymer matrix.

Other manufacturing processes such as E-beam etching may produce a very high resolution (e.g. 1-10 -nm). The resolution of the manufactured periodic hole structure may be set by practical recording angles and wavelength. This resolution may be in hundreds (100s) of nanometers. However, even at these lower resolutions, the manufactured periodic hole structure may be used for various applications such as the storage of biofuels. Further, holographic recording has major advantages over other manufacturing processes such as E-beam etching. Large areas can be recorded with high throughput whereas E-beam etching is slow which makes creating large deep cavities a slow process and only suitable for short runs. Holographic recording also offers much greater flexibility in the types of structures that can be recorded range from basic 2D gratings to 3D photonic crystals. Holography can yield deep cavities of the order of microns depth. In some examples, E-beam lithography may be utilized for fine tuning the geometry of holographically-formed cavities.

A multiplexed EPS may be applicable in other situations besides display devices. As discussed in the reference filings, in many embodiments, the grating modulation pitch, slant and other properties may be spatially-varying. The properties of any backfill material may also have a spatial variation.

### Embodiments Including Harmonic Gratings Used in Biosensors

It has been discovered that the techniques described above for creating multiplexed gratings including harmonic gratings including periodic holes in a grid may be used for biosensors. An example of a fabricated multiplexed EPS grating is described in connection with FIG. 14A-14C and also described in connection with FIG. 4A and FIGS. 4B-1 through 4B-4. It has been discovered that these structures may be used for an ultra low cost biosensor which is configured to store biofluids or biomaterials including proteins for analysis in the holes. In some embodiments, the doping of the photopolymer material may be optimized to preferentially attach to proteins. An additional ashing process may create clean hole without weakening polymer networks. In some embodiments, the weak polymer networks may be left by not performing the additional ashing process or not performing the ashing process until all of the weak polymer networks are removed. The weak polymer networks may act as binding points for proteins. In some embodiments, an additional deposition process may be performed after washing the grating of non-reactive material. The additional deposition process may deposit a material on the structures which allows the structures to more effectively store the proteins. The additional deposition process may be atomic layer deposition (ALD). In some embodiments, a backfill material may be backfilled into the holes which may preferentially bind with some biological species and not others. The formed structure may form sensors for sensing biological species.

In some embodiments, structures may be doped with at least one chemical that interacts with molecules of a test sample leading to changes in the material and/or optical properties of the structure such as, for example, changes in the color of light diffracted from the sample.

For example, the structures may be doped to produce zeolite nanoparticle doped biosensors. Zeolite nanoparticles may be used for the functionalization of photopolymer-based sensors. They are particularly well suited to gas sensing due to their porosity, which allows for increased adsorption of gas molecules and selectivity. Zeolite nanoparticles may be low-density crystalline aluminosilicates possessing regular micropores of dimensions matched to typical molecular sizes (e.g. 0.3-2.0 nm). These micropores (one-, two-and three-dimensional) may create a vast network of channels and cages with well-defined sizes and shapes, which act like a molecular sieve. The structures may also be doped with other materials with similar sieving properties include the zeotype materials, containing different tetrahedral (e.g. Si, Al, Ti, P, Ga, Ge, B) framework cations. Nanozeolite doped photopolymers are discussed in Zaarour, M. et al, Micropor. Mesopor. Mater. 189,11 (2014) which is hereby incorporated by reference in its entirety for all purposes. In many embodiments, the structures may be acrylamide-based photopolymer nanocomposites containing a plurality of different zeolite nanoparticles. The photopolymer nanocomposites may include varying microporosity. The plurality of different zeolite nanoparticles may include Silicalite-1 (MFI-structure, Ø=30 nm), AIPO-18 (AEI-structure, Ø=180 nm), and/or Beta (BEA-structure, Ø=40 nm). Examples of photopolymer nanocomposites containing a plurality of different zeolite nanoparticles are described in Naydenova, I., et al, “Optical properties of photopolymerizable nanocomposites containing nanosized molecular sieves,” J. Opt. 13, 044019 (2011 ) which is hereby incorporated by reference in its entirety. In many embodiments, structures may be recorded in BEA-and MFI-type zeolite-doped acrylamide photopolymer layers for sensing analytes such as toluene and isopropanol. Examples of photopolymer layers for sensing toluene are described in Leite, E., et al, “Photopolymerizable nanocomposites for holographic recording and sensor application,” Appl. Opt. 49, 3652 (2010 ) which is hereby incorporated by reference in its entirety for all purposes. The dopant may be an analyte-sensitive dopant and diffusible within the material during holographic recording to produce dopant-rich and dopant-poor regions.

In many embodiments, the structures may include diacetone-acrylamide-based photopolymer doped with BEA type zeolite nanoparticles which may be used to improve the refractive index modulation of the polymer structure. Examples of these are described in Cody, D., et al, “Effect of zeolite nanoparticles on the optical properties of diacetone acrylamide-based photopolymer,” Opt. Mater. 37, 181 (2014) which is hereby incorporated by reference in its entirety. In many embodiments, the redistribution of the zeolite nanoparticles may take place via a phase separation process. The zeolite pores may remain empty due to the larger size of the monomer molecules compared with the nanoparticle pore sizes. Gas molecules can be adsorbed inside the BEA zeolite pores (depending on the gas molecule size) as well as to the zeolite surface, potentially maximizing the gas molecules'effect on the refractive index modulation change. The synthesis of BEA zeolites is described Naydenova, I. et al, “Optical properties of photopolymerizable nanocomposites containing nanosized molecular sieves,” J. Opt. 13, 044019 (2011). BEA zeolites are hydrophilic, which ensures they are compatible with the water-soluble diacetone acrylamide (DA) photopolymer. Advantageously, DA monomer has reduced toxicity in comparison to the acrylamide (AA) monomer, reducing the risk of occupational and environmental hazards.

In many embodiments, the structures may be utilized as sensors for the gaseous phase materials. The sensor may have reversible hydrophobic interactions with gaseous analytes. Examples include sensors for hydrocarbons and volatile organic compounds. These substances have aliphatic chains that can hydrophobically interact via Van der Waals'forces. Hydrophobic interactions are typically capable of triggering sensing action in holographic sensors and are reversible. The volatile organic compounds that may be detected include: high molecular weight ketones, alcohols and hydrocarbons in the liquid state such as n-pentane, 1-pentene, 1-pentyne, hexane, heptane, octane, decane, 4-methyl-2-pentanone, heptanone, hexanol, heptanol, iso-amyl alcohol, and/or tert-amyl alcohol.

In many embodiments, the structures may be utilized as sensors for O₂, N₂, Alkanes, Alkenes, Alkynes, and/or NH3. Oxygen and ammonia can form weak dipoles upon interaction with other molecules or species and are able to form reversible covalent bonds due to partial charges in their molecular structure. The sensor may detect these gases by exploiting the nature of their molecular interactions while taking into account the high reactivity of these gases. The sensor response may be affected by the combined effects of refractive index changes and swelling. Advantageously, dopants for detecting oxygen or ammonia may selectively accept charged or partially charged molecules and generate molecular changes that affect either refractive index or swelling. In many embodiments holographic oxygen and ammonia sensors may incorporate ion-exchange membranes with high transparency, and selective interaction with charged or partially charged molecules.

In many embodiments, the structures may be utilized as sensors for sensing acidity or alkalinity (pH sensors). pH sensors may include pendant carboxyl groups that are introduced to the polymer matrix by adding methacrylic acid in the monomer solution before free radical polymerization. Examples of this process are described in Naydenova, I., et al, “Photopolymers: Beyond the Standard Approach to Photosensitisation,” J. Eur. Opt. Soc.-Rapid 4, 09042 (2009 ). In various embodiments, the sensors may be transmission or reflection sensors. A reflection-type pH sensor may be configured for pH measurements in the range from pH 4-7, producing Bragg peak shifts up to 350 nm with response time within 30 seconds.

In many embodiments, the structures may be utilized as sensors for metal ions. In many embodiments, sensors for sensing metal ions may be functionalized with crown ethers incorporated in the polymer matrix. In many embodiments, methacrylate derivatives may be synthesized according to the methods disclosed in A. G. Mayes, A. G., et al, “Metal Ion-Sensitive Holographic Sensors,” Analytical Chemistry. 74, 3649 (2002) which is hereby incorporated by reference in its entirety for all purposes. In many embodiments, the methacrylate derivatives may include methacrylate 12/15/18-crown-4/5/6, which are copolymerized with hydroxyethyl methacrylate (HEMA) to form a pHEMA matrix with pendant crown ethers. The 18-crown-6 (50 mol %) holograms with a cavity diameter of 2.6-3.2 Å may be sensitive to K+ ions.

In many embodiments, the structures may be utilized as sensors for divalent metal ions. Sensors for detecting divalent metal ions may be functionalized with a porphyrin derivate, which also provides a crosslinker. For example, a sensor configured to detect Cu2+ and Fe2+ ions (0.05-1.00 M), may demonstrate a Bragg peak shift of around 5 nm as disclosed in A. K. Yetisen, A. K., et al, “Pulsed laser writing of holographic nanosensors,” Mater. Chem. C 2, 3569 (2014) which is hereby incorporated by reference in its entirety for all purposes. The low signal level encountered in such applications normally requires spectrophotometric detection. In many embodiments, holographic sensors for divalent metal ion sensing may be functionalized with 8-hydroxyquinoline.

In many embodiments, the structures may be utilized as sensors for detection of water content. The hygroscopic properties of gelatin can be used in reflection-type holographic sensors for detecting water content in hydrocarbons.

In many embodiments, the structures may be utilized as sensors for detection of glucose. The sensors for measuring glucose concentrations may include an acrylamide matrix functionalized with 3-(acrylamido)-phenylboronic acid to form pendant cis-diol moieties as disclosed in Kabilan, S., et al, “Holographic glucose sensors.” Biosens. Bioelectron. 20,1602 (2005) which is hereby incorporated by reference in its entirety for all purposes. In various embodiments, holographic glucose sensor may be configured to operate over the visible to near infrared bands.

In some embodiments, the sensor includes a range diffractive structures formed in polymer for detecting a variety of substances. In many embodiments, the diffractive structures are Bragg gratings. The diffractive structures may be photonic crystals recorded as three-dimension lattices of various geometries. The practical implementations of the sensor range from the visual display of changes in color, reflected light intensity, polarization, etc. resulting from the modification of the diffractive properties of the sensor material (typically provided as a layer on a thin substrate) by an analyte in contact with the substrate to more complex solutions integrating light detectors. In some embodiments, the sensor may be connected to electronics read out circuitry, communications, analyte storage and conveyance and many other functions. In many embodiments, the sensor may be integrated within a lab on a chip sensor architecture. In many embodiments, the sensor may be implemented using disposable substrates made from plastic and/or paper.

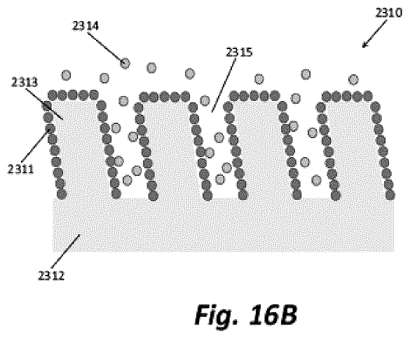

FIGS. 16A and 16B illustrate various embodiments of a biosensor including a dopant. In these embodiments, the dopant is positioned in different areas of diffracting features. FIG. 16A is a schematic cross-sectional view of a biosensor in contact with an analyte in accordance with an embodiment of the invention. The biosensor includes a diffractive structure 2300 including a substrate 2301 supporting diffracting features 2302 separated by air spaces 2303. The diffractive features 2302 may be of any shape including but not limited to rectangular, triangular, trapezoid, parallelogram in unslanted or slanted configurations. The diffractive features 2302 may have a fixed spatial frequency, duty cycle, and height or may have a spatial variation of one or more of these parameters. The substrate 2301 and diffractive features 2302 may be formed of different materials. For example, in many embodiments, the substrate 2301 is a glass or plastic that supports a layer of recording material into which the diffractive features 2302 is recorded. In some embodiments, the substrate 2301 may include a bias layer of the same material as the diffractive features 2302 formed in the grating formation process. In such cases the bias layer is formed on top of a substrate 2301. In many embodiments, the substrate 2301 is transparent. In some cases, the substrate 2301 may not be transparent such as such as cases where the biosensor forms part of an electronics backplane. In many embodiments, the diffractive features 2302 are a polymer formed by phase separating a holographic recording mixture comprising monomer and inert component, the latter being removed after curing of the hologram to form the polymer diffractive structure. In many embodiments the inert component is a liquid crystal (LC). The inert component may also include nanoparticles and/or inert liquids. In many embodiments, the diffracting features 2302 may be doped with a dopant 2304 that reacts with analyte molecules 2305 after curing of the recorded grating. The analyte molecules may in a gaseous state or suspended in a liquid. The doping may be applied to the surfaces of the diffractive features 2302.

In some embodiments, the dopant 2304 may be suffused into pores or holes which form naturally in the course of polymerization. As monomers react and bind with the growing polymer radicals, holes may be generated due to the covalent single carbon bond in the polymer being around 50% shorter than the van der Waals bond in the liquid monomer state. For similar reasons, the polymer diffractive features 2302 also may have a rough surface. While this presents a source of scatter (e.g. haze in display applications), surface roughness and bulk material inhomogeneity may be useful structures for dopant backfilling. The hole dimensions and surface roughness feature sizes are determined by the efficiency of phase separation. In the HPDLC system, holes can be in the nanometre to tens of nanometres size but may be bigger as a result of holes coalescing. Holes and surface roughness also may result from the extraction of the inert component from the polymer-rich regions.

In many embodiments, the dopant 2304 may form part of the holographic recording mixture, such that the final polymer/dopant matrix formation takes place in parallel with the phase separation of the monomer and inert component. In many embodiments, the dopant 2304 may not participate in the polymerization process. Thus, the initial holographic mixture may include a mixture of monomer, inert material, and dopant among other substances. Advantageously, the dopant 2304 may have diffusing properties conducive to forming a high concentration in the polymer rich regions. In many embodiments, phase separation of such mixtures may result in polymer rich regions containing a high concentration of dopant 2304 separated by inert component rich regions in which the dopant concentration is much lower. The inert component and any dopant suspended within the inert component may be removed or evacuated to leave a grating including doped polymer features separated by air gaps. In such embodiments, the dopant 2304 may be a functionalized monomer or a functionalized nanoparticle. Functionalization may determine the interaction of the dopant 2304 with biological environment and also the detectability of the signal detected using direct viewing, spectroscopy or electronic imaging. In some cases, the dopant may be functionalized by incorporation of a fluorescent dye to enable imaging of the dye's interaction with certain molecules using techniques such as fluorescence microscopy. Surface modification of nanoparticle dopants may be used to affects characteristics including surface chemistry, size, hydrophilicity, hydrophobicity, electrical charge, etc in order to enhance detected signals or images. Nanoparticles may have their surfaces modified by the use of techniques such as qas surface epitaxial growth or amorphous coatings.

The diffractive features 2302 may include slanted or unslanted gratings, arrays of cavities of any cross section geometry and array pattern, photonic crystal structures of any order and geometry and may exhibit spatial variations in height, duty cycle, refractive index, polymer-dopant ratio.

The reactions between the dopant 2304 and analyte 2305 results in changes to the grating properties such that under illumination 2306 from an external source, which is reflected as reflected light 2307, exhibits a shift in the Bragg diffracted peak wavelength. Such behaviour may result from changes to the refractive index, thickness, birefringence, slant angle, spatial frequency and other parameters. The external source may be natural light or emission from an artificial source such as a laser or LED. In many embodiments, light may be directed onto the diffractive structure 2300 using a waveguide. In various embodiments, the reaction between the dopant 2304 and the analyte molecules 2305 may give rise to changes to the grating material that result in changes to the peak diffraction direction, polarization and other characteristics. The dopant 2304 may be molecules or nanoparticles, depending on the sensing application.

FIG. 16B a schematic cross-sectional view of a biosensor in contact with an analyte in accordance with an embodiment of the invention. The biosensor includes a diffractive structure 2310 which includes a substrate 2312 supporting diffracting features 2313 separated by air spaces 2315. A dopant is dispersed in a layer 2311 across a surface of the diffracting features 2313 of the diffracting structure 2310 using a coating process. As illustrated, the dopant may be dispersed in a layer 2311 across the sides and tops of the diffracting features 2313. In some embodiments, the dopant may also be positioned on the substrate 2312 surface portions at the bottoms of the air gaps 2315.

The embodiments of FIGS. 16A and 16B may be used to implements SERS. In such cases, the dopants may include nanoparticles or coatings formed from noble metals such as gold or silver. The light source may be a laser of a specific wavelength.

Precise alignment of the laser and the surface plasmons may provide maximum amplification of the Raman scatter from a molecule to be detected. Periodic nanostructures are effective for eliminating the momentum mismatch of the wave vectors of the incident laser light and the surface plasmon polaritons (e.g. the collective oscillation waves of free electrons localized at the optical interface between metal and dielectric media). The diffracted orders of a grating structure interface exhibit larger wavevector magnitudes than those of incident waves.

In the biosensors described in FIGS. 16A and 16B, the diffractive structure height can be greater than the grating pitch. Such gratings may operate substantially in the Bragg regime allowing greater diffraction efficiency and angle and wavelength selectivity than is possible using thinner gratings. Importantly for sensor application, deep gratings and may benefit from an increased effective area of contact between the analyte and dopant.

In some embodiments, the dopants may be added to the already manufactured polymer grating structure to modify the diffractive response in the presence of an analyte. The dopants can be applied in a layer on top of the surface of the polymer grating structure and/or on exposed portions of the supporting substrate. Examples of processes of manufacturing polymer grating structure and examples of polymer grating structures are described above in FIGS. 4A and 4B.

In many embodiments, the dopants may include functionalized nanoparticles. Functionalized nanoparticles may have cores and/or one or more coating layers which may react with analyte molecules. In various embodiment, the nanoparticles may be spherical or cylindrical (e.g., nanorods). In many embodiments, the nanoparticles may be nanostars.

In many embodiments, the monomers in the initial mixture of monomer and inert material may have molecular structures which may influence the formation of polymer structures suitable for hosting dopants. The dopant may form part of the initial holographic recording mixture (e.g. 254A of FIG. 4B-1) which can be redistributed in the photopolymer matrix during holographic recoding to form dopant-rich and dopant poor regions. The reaction of the dopant and analyte may change the diffractive properties of the structure by modifying refractive index, slant, thickness, birefringence, diffracting feature shape and other properties, resulting in changes in the Bragg peak response in color and angle and/or intensity of light diffracted from the structure. Where the signal is weak the hologram responses may be recorded using spectrophotometry.

The sensitivity of the sensor to a specific molecular stimulus may be from changes in the properties of the polymer matrix functionalized with stimuli responsive dopants. The sensor may be formed from a mixture of a monomer and an inert component such that the inert fluid (e.g. nanoparticle, liquid crystal) which may provide deep structure with spatially varying duty cycle. Porosity which would normally be an issue for displays may be used for backfilling the polymer structure. This may include considerable scope to functionalize the structure to respond to different analyte components and their spatial variation. Absorption, diffusion, swelling, and ionic dissociation may affect the sensing process.

For volume holograms, in cases where the inert material is not removed, layer permeability may be an issue, because the analyte needs to diffuse through the polymer layer to cause a detectable change in the hologram's characteristics. In many applications, the polymer matrix may be sufficiently robust to maintain the photonic structure under multiple cycles of exposure to the analyte's environment. This may balance permeability with stability of the photonic structure. The photopolymerizable material may include acrylamide monomers and poly(vinyl alcohol) PVA which may produce holograms that shift their reconstruction wavelength with complete reversibility through many cycles of low and high humidity. In many embodiments, slanted holographic gratings can provide enhanced sensitivity, especially when the layer can swell/shrink. In many embodiments, reactions with analytes may induce changes in orientation of gratings due to induce elasticity. In many embodiments, the incorporation of a diffractive structure, into a SERS substrate results in enhanced SERS signals that are inherently wavelength-dispersed, thus enabling simpler designs of SERS-based sensors without a spectrometer.

In some embodiments, the diffractive structure may increase the surface area in contact with the analyte and hence increase the probability of chemical reaction. This can be achieved by forming a deep SRG which has a grating height greater than the grating pitch. Increasing the analyte contact area is important in sensors using Raman scattering, such as Surface Enhanced Raman Spectroscopy (SERS). The increase in surface area is largely influenced by the height of the diffracting features. Nanoparticles deposited on the surface may further increase the surface area.

In various embodiments, the sensors may be fabricated in hydrophilic materials for sensing in aqueous solutions. In many embodiments, the sensors may be fabricated in hydrophobic materials for non-aqueous applications. In various embodiments, the sensor may be configured for detecting hybrid materials by the integration of multianalyte holographic sensing by having hydrophobic and hydrophilic domains.

In sensors based on SERS principle plasmonic resonance material may be introduced into the pores of the polymer diffracting nanostructure or as an overcoating on top of the structure. In many embodiments, the sensor may incorporate SERS material liquid crystal. Incorporating liquid crystal may enable surface plasmon resonance substrates that can be cheaply reconfigured for detecting specific molecules. Surface plasmon and liquid crystals can also, in some embodiments, be used for spatially and/or temporally varying the characteristic of surface plasmons.

In some embodiments, structures may be configured for use with light emitters to stimulate emission or scatter from molecules in a test sample. The light emitters may be lasers or LEDs. The light emitters may be used to excite emissions from an analyte in contact with the sensor. The emitters may illuminate the sensor and analyte directly through the grating or may be delivered via a waveguide. The function of the sensor may be to control the direction and phase of the incoming beam for most favorable stimulation of the analyte. The sensor may also play a role in coupling emission from the analyte into a path towards a detectors (which may take place via a waveguide).

In some embodiments, structures may be configured to amplify emission or scatter from molecules in a test sample. In some embodiments, the structures may be configured to direct emission or scatter from molecule in a test sample to a detector. In some embodiments, structures may be integrated with a waveguide used to convey and direct pump radiation onto a sample material.

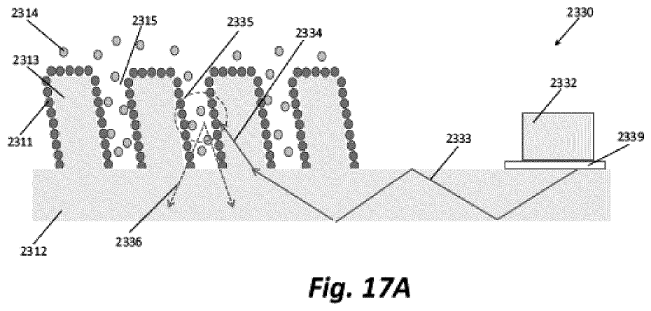

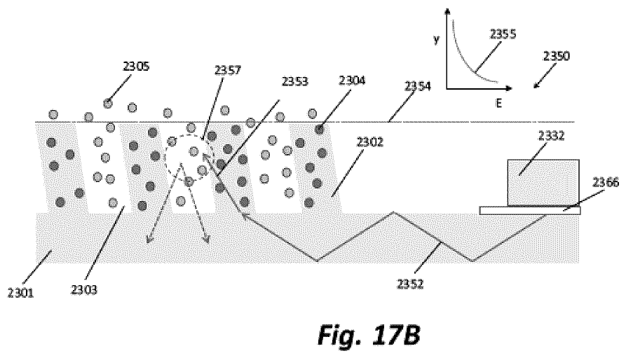

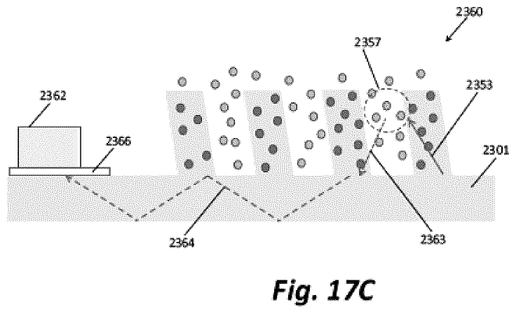

FIG. 17A is a cross section of an embodiment of a biosensor 2330 including a waveguide, a laser source, and input coupling module in accordance with an embodiment of the invention. FIG. 17A includes many identically labelled features as those in FIG. 16B. The description in FIG. 16B is applicable here and will not be repeated in detail. The substrate 2312 may be a waveguide. A laser source 2332 may input light into a coupling optics 2339 which may be a prism or a grating. The coupling optics 2339 incouples the light into the waveguide 2312. The in-coupled light propagates along an optical path 2333, 2334 by total internal reflection or more generally via guided wave modes and interacts with the diffractive features 2313, the dopant 2311, and the analyte molecules 2314 within an interaction region 2335 determined by the beam cross section to provide an output signal 2336 for detection.

FIG. 17B is a cross section of an embodiment of a biosensor 2350 including a waveguide, a laser source, and input coupling module in accordance with an embodiment of the invention. FIG. 17B includes many identically labelled features as those in FIG. 16A. The description in FIG. 16A is applicable here and will not be repeated in detail. The substrate 2301 may be a waveguide. A laser source 2332 may input light into a coupling optics 2339 which may be a prism or a grating. The coupling optics 2339 incouples the light into the waveguide 2301. The guide beam 2352, 2353 interacts with the diffractive features 2302, the dopant 2394, and the analyte molecules 2305 via an evanescent coupling region 2357 have an electric field (E) versus vertical coordinate (y) characteristic 2355 matched to the thickness 2354 of the diffractive features 2302.

FIG. 17C is a cross section of an embodiment of a biosensor 2360 in accordance with an embodiment of the invention. The biosensor 2360 utilizes the similar identically labelled features described in connection with FIG. 17B. The description in FIG. 17B is applicable here and will not be repeated in detail. In FIG. 17C, the waveguide 2301 includes a photodetector 2362 which receives light from an output coupler module 2366. The evanescent coupling region 2357 diffracts the light into a signal light path 2363, 2364. The signal light path 2363, 2364 is in a directionality such that the output coupler module 2366 outputs the light into the photodetector 2362. The outcoupling optics 2366 may include a prism or a grating.

In some embodiments, the structures may be integrated with a waveguide used to convey emission or scatter from molecules in a test sample to a detector. In some embodiments, the structures may form a host structure for materials that react with molecules to be detected. In some embodiments, the structures may form a host structure for materials to be analysed using material analysis by spectroscopic means. In some embodiments, the structures may form a host structure for materials to be subjected to chemical processing.

In some embodiments, the structures may include gratings. In some embodiments, the structures may include photonic crystals. In some embodiments, the structures may include arrays of cylindrical cavities which form periodically arranged holes embedded within a polymer matrix. In some embodiments, the structures may be doped with material providing at least one of electrical conductivity, electrically variable birefringence, and/or piezoelectric properties. In some embodiments, the structures may be responsive to at least one of thermal, electrical, magnetic, chemical, mechanical, and/or electromagnetic stimuli.

In some embodiments, the structures may be backfilled with materials for interacting with molecules to be detected. In some embodiments, the structures may be formed from polymers doped with chemicals or polymers with intrinsic chemical properties. In some embodiments, the structures may be formed from polymers with intrinsic chemical properties for detecting specific molecules. In some embodiments, the structures with index modulation or average index or birefringence may be changed by the presence of molecules.

In some embodiments, the structures may be fabricated using EPS fabrication processes involving at least one of ink jet printing, holographic lithography, mask lithography, ashing, and/or thin film coating deposition.

In some embodiments, the structures may be configured for the detection of gases, liquids, particulate phases, and/or multiphase systems. In some embodiments, the structures may be configured for the detection of more than one type of molecular structure.

In many embodiments, the polymer structures (e.g. gratings) discussed above may be formed in an electro-responsive polymeric material. Such materials can exhibit swelling, shrinkage, bending and other structural deformations, in response to an electrical field where the nature of the electrical to mechanical energy transformation depends on voltage, current, duration of the electrical pulses and interval between pulses.

Electro responsive polymers essentially fall into two groups: electronic electroactive polymers(EEAPs) and ionic electroactive polymers (IEAPs).

EEAPs are driven by external electric fields and by Coulomb forces and may include materials such as piezoelectric polymers, electrostrictive polymers, and dielectric elastomers. Although they utilize high electrical field strengths of the order of tens of volts per micron to produce a mechanical deformation, EEAPs benefit from high efficiency, and short response times.

IEAPs are driven by the movement of ions or molecules and include polyelectrolyte gels, ionic polymer-metal composites, and conducting polymers. Although such materials allowing large deformations at low activation voltages (about 1-5 volts per micron), they usually require immersion within an electrolyte medium. The electrolyte medium limitation may. be overcome by new ionic liquid/electroactive polymer composites which offer potential for improved stability and low voltage operation.

Gels in which ion movement is influenced by a DC electric field offer potential for shape control e.g. by producing swelling at one end of a gel nano rod and shrinkage at the other end. Examples of such gels are polyacrylic acid gel (polyelectrolyte) or electroactive polymer gel.

In some embodiments, the structures may be integrated with polymer electronics for detection and/or wireless communication. In some embodiments, the structures may be integrated into hybrid plastic/silicon electronics. In some embodiments, the structures may be incorporated into electromechanical devices (e.g. microfluidics). In some embodiments, the structures may be integrated into polymer electronics for detection, and/or wireless communication. In some embodiments, the structures may be integrated into hybrid plastic/silicon solutions. In some embodiments, the structures may be configured for specific wavelength bands (e.g. visible band, IR, millimeter wave, and/or microwave).

The structures may include periodic nanoholes which may include a deep high aspect ratio. For example the aspect ratio may be 2 μm depth on 400 nm pitch. The nanoholes may be slanted. There may be two dimensional surface period control.

### Embodiments Including Nanopillars

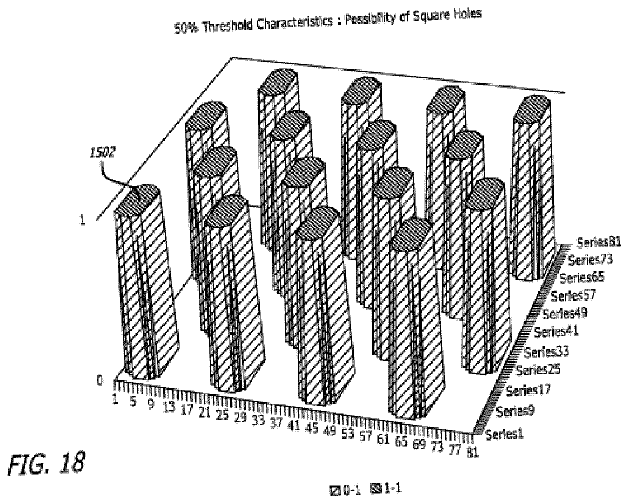

In various embodiment, changing the duty cycle of the phase separation to <50% may cause an inversion in the structure from nanoholes to nanopillars. Thus, instead of holes, pillars may be fabricated. According to Babinet's principle, the diffraction characteristics of pillars as opposed to holes remain unchanged since the diffraction pattern resulting from an opaque obstacle which may be identical to that from a hole of the same size and shape except for the overall forward beam intensity. FIG. 18 schematically illustrates examples of pillars in accordance with an embodiment of the invention. The pillars 1502 may be fabricated through the above discussed phase separation process. The pillars 1502 may be nanopillars. In some embodiments, the pillars may be slanted. Slants can be spatially varied in 2 dimensions, e.g. rolling K-vector (RKV) pillars. The same spatially varied slant may be present in holes. As with holes, the spatial period of the pillars can be adjusted in x and y dimensions. Height (the z-axis) can be controlled with initial cell gap (e.g. set by print volume and/or spacer beads). Post ashing can be used to modify the height. Changing the x and y dimensional periods may produce pillars with approximately elliptical cross sections, whereas equal x and y periods may produce approximate cylindrical columns (with approximately circular cross sections). The same principal may be applied to produce elliptical cross sectional holes embedded in a polymer matrix. Post processing (e.g. ALD) coating may be applied to strengthen the pillars. Thick ALD layers may be applied. Other coating processes other than ALD (e.g. PVD, CVD) can also be used to apply thicker layers which can help to smooth sidewall roughness of the pillar structures. The diameter of the pillars may be increased with the additional post processing coating. For example, the diameter of the pillars may be enhanced after they are formed. The width of the pillar columns can increased to change the diffraction efficiency characteristics.

### Embodiments Including Application of Sheer Force

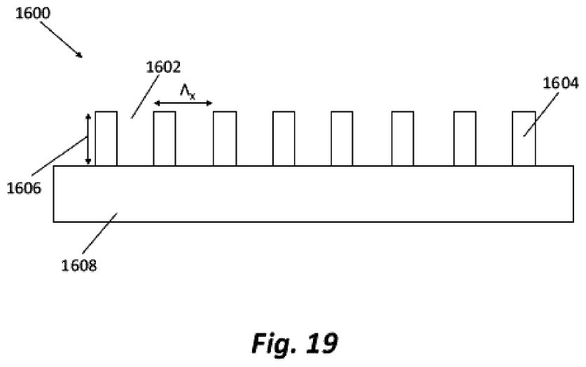

A shear force may be applied to the gratings to produce a bent slanted grating. Bent slanted gratings may include increased angular response because the slant changes through the volume of the grating. FIG. 19 schematically illustrates a structure in accordance with an embodiment of the invention. As illustrated, the structure 1600 includes a surface relief grating with air 1602 between polymer fringes 1604 positioned on a glass bottom substrate 1608. The glass bottom substrate 1608 is an optical substrate. The height 1606 of the polymer fringes 1604 may be between 0.1 to 5 μm. The polymer fringes 1604 may include no slant and may include a period Λₓ across the EPS structure 1600. Immersing the EPS structure 1600 with a backfill polymer may create a backfill with a different index of refraction in the backfill area thereby generating an index modulation. The backfill polymer may be a doped polymer. The backfill polymer may subsequently be cured. The curing may be performed optically, thermally, or through drying time. Curing may allow the attachment of a top cover plate. The structure of FIG. 19 may be an intermediate diffractive structure. The structure 1600 of FIG. 19 may be created using the process described in connection with FIG. 4A and FIGS. 4B-1 through 4B-4. The structure 1600 may be a two-dimensional array of holes as illustrated in FIG. 15. The holes may be elongated in a direction orthogonal to a bottom substrate. The holes may form a harmonic grating.

In some embodiments, the structure 1600 of FIG. 19 may be a two dimensional array of polymer elements in contact with a bottom substrate as illustrated in FIG. 18.

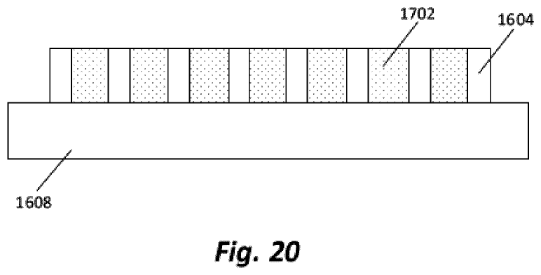

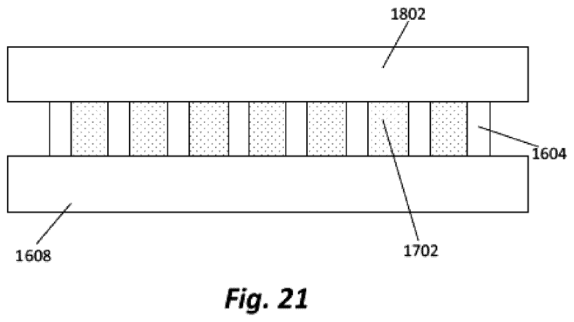

FIG. 20 illustrates the EPS structure of FIG. 19 with a backfill material. The backfill material 1702 may fill in the air 1602 between the polymer fringes 1604. FIG. 21 illustrates the EPS structure of FIG. 20 with a top substrate 1802. The top substrate 1802 is applied above the backfill material 1702 and the polymer fringes 1604. The top substrate 1802 may include glass, plastic, and/or sapphire.

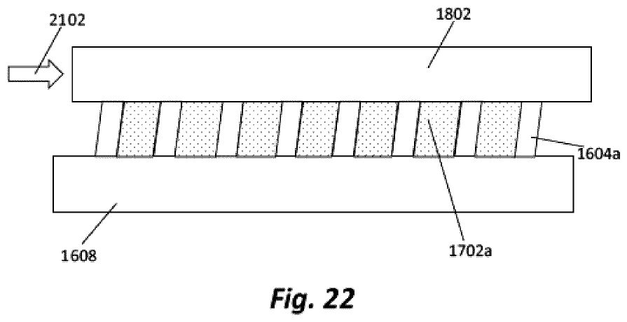

A shear force may be applied to the cover substrate which may move the top of the backfill material 1702 and polymer fringes 1604 while the bottom of the backfill material 1702 and the polymer fringes 1604 remain stationary. In some embodiments, for large area substrates, a mechanical shear force may be applied by a squeegee blade or a roller traversed across a partially cured grating structure. FIG. 22 illustrates the EPS structure of FIG. 21 after a shear force 2102 is applied to the cover substrate 1802. As illustrated, the top substrate 1802 may shift the backfill material 1702a and the polymer fringes 1604a to produced bent slanted backfill material 1702a and polymer fringes 1604a. The bent slanted backfill material 1702a and the polymer fringes 1604a may have a slant angle which changes throughout the volume. Before applying the sheer force, the backfill material 1702 may be pre-gelled to generate a friction/attachment force between the top substrate 1802 and the EPS polymer fringes 1604. In some embodiments, a precuring process can be performed to bond the polymer fringes 1604 to the top substrate 1802 prior to applying a shear force. Once the shear force is applied, the top substrate 1802 may be held and fully cured to produce slanted polymer fringes 1604a and backfill material 1702a.

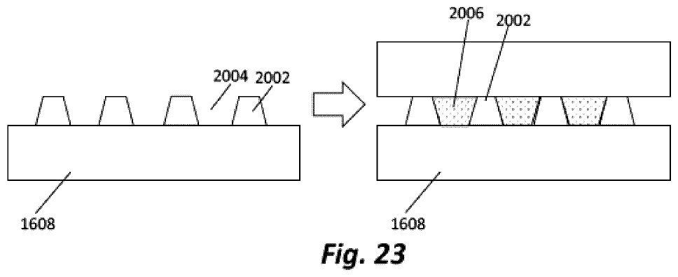

The concepts described in connection with FIGS. 19-22 may be applied to tapered gratings. FIG. 23 illustrates applying a cover substrate and backfill material to a tapered grating. Initially, the tapered grating 2002 may include air gaps 2004. The tapered grating 2002 may be produced by first producing polymer fringes 1604 as illustrated in FIG. 19 and then performing an ashing/etch step. Alternatively, a subsequent deposition process on the polymer fringes 1604 may be used to produce the tapered grating 2002. The air gaps 2004 may be filled with a backfill material 2006. The backfill material 2006 may occupy spaces between the polymer fringes of the tapered grating 2002. A cover substrate 1802 may be applied to the backfill material 2006 and the tapered grating 2002.

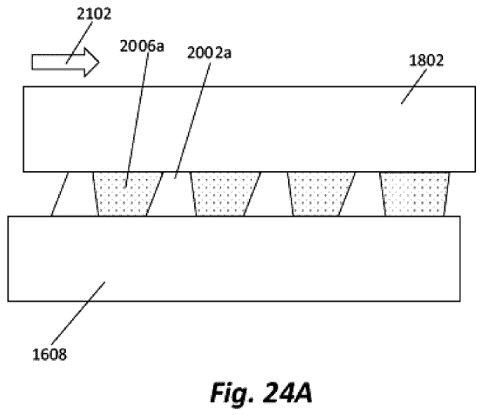

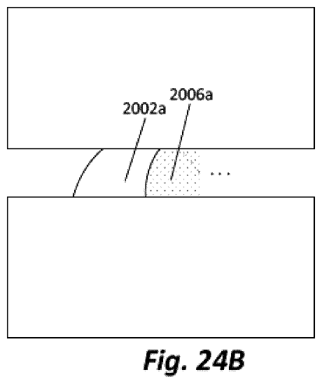

Similar to the process described in connection with FIG. 22, a shear force 2102 may be applied to the cover substrate 1802 which may produce a bent slanted tapered grating 2002a. FIG. 24A illustrates applying a shear force to the tapered grating of FIG. 23. As illustrated, the shear force 2102 may produce a bent slanted tapered grating 2002a with bent slanted backfill material 2006a inbetween. The bent slanted tapered grating 2002a may include a bending effect on fringes. FIG. 24B illustrates a bent tapered grating after the shear force of FIG. 22. In some embodiments, bending the fringes may change the slant through the volume which in turn increases the angle with response of the grating.

In some embodiments, the backfill material 1702, 2006 may not be present if sheer force can be achieved between the cover substrate 1802 and the grating 1604, 2002. In some embodiments, a thin adhesion/friction promoter may be applied on the inside surface of the cover substrate 1802 which may contact the grating 1604, 2002. In some embodiments, a down force may be used to increase friction between the grating 1604, 2002 and the cover substrate 1802 such that lateral force moves the grating 1604, 2002 to create slants.

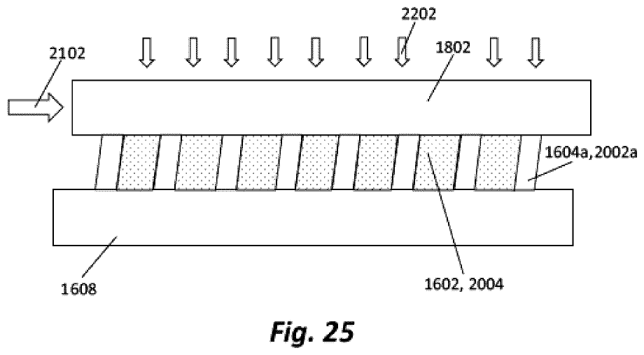

FIG. 25 illustrates applying a shear force while applying a down force or pressure to the grating. The down force 2202 may be applied to the cover substrate 1802 while applying a shear force 2102 which may produce a bent slanted grating 1604a. The same concept may be used to produce a bent slanted tapered grating 2002a.

Not including the backfill material 1702, 2006 may make it easier to bend the grating 1604, 2002. The air gaps 1602, 2004 may provide less resistance to the share force 2102. The shear force technique described herein may be applied to gratings including lines, rolling K-vector (RKV), nano-pillars, and/or holes as discussed above.

Gratings of the types shown above may be further processed following curing using UV or thermal exposure. Modulation depth of nanostructures formed using holographic exposure of photopolymers may decrease with increasing nanostructure spatial frequency. However, thermal post processing has been found to increase modulation at high spatial frequencies.

Although only a few embodiments of the invention have been described in detail, it should be appreciated that the invention may be implemented in many other forms without departing from the spirit or scope of the invention. For example, embodiments such as enumerated below are contemplated:
Clause 1. A method for fabricating a diffractive structure, the method comprising: providing a bottom substrate; coating a mixture of an inert material and a monomer onto the bottom substrate; providing a first top substrate to position the mixture between the bottom substrate and the first top substrate; applying holographic exposure to the mixture to form an intermediate diffractive structure comprising a polymer matrix separated by inert material rich regions; removing the first top substrate; evacuating the inert material from the inert material rich regions leaving an evacuated diffractive structure where the inert material rich regions have been replaced with air; providing a second top substrate which adheres to the top surfaces of the polymer matrix; and applying mechanical force to the second top substrate while the bottom substrate remains stationary to change the profile of the evacuated diffractive structure.
Clause 2. The method of clause 1, wherein evacuating the inert material produces a two-dimensional array of holes within a polymer matrix and extending from the bottom substrate, wherein the holes are elongated in a direction orthogonal to the bottom substrate.
Clause 3. The method of clause 2, wherein applying holographic exposure to the mixture comprises a first holographic exposure and a second holographic exposure which has a different orientation from the first holographic exposure.
Clause 4. The method of clause 1, wherein evacuating the inert material results in a two-dimensional array of polymer elements in contact with the bottom substrate and surrounded by air, wherein the polymer elements are elongated in a direction orthogonal to the bottom substrate.
Clause 5. The method of clause 4, wherein applying holographic exposure to the mixture comprises a single holographic exposure.
Clause 6. The method of clause 1, wherein the diffractive structure is a surface relief grating.
Clause 7. The method of clause 1, wherein applying the mechanical force to the second top substrate comprises applying pressure to the evacuated diffractive structure along a direction orthogonal to the interface between the bottom substrate and the evacuated diffractive structure.
Clause 8. The method of clause 7, applying the mechanical force to the second top substrate comprises applying a shear force to the second top substrate along a direction parallel to the interface between the bottom substrate and the evacuated diffractive structure, wherein the position of the base of the diffractive structure remains fixed relative to the bottom substrate.
Clause 9. A method of forming a biosensor, the method comprising: providing a bottom substrate; coating a mixture of an inert material and a monomer onto the bottom substrate; providing a first top substrate to position the mixture between the bottom substrate and the first top substrate; applying holographic exposure to the mixture to form an intermediate periodic structure comprising a polymer matrix separated by inert material rich regions; removing the first top substrate; evacuating the inert material from the inert material rich regions leaving an evacuated periodic structure where the inert material rich regions have been replaced with air within the polymer matrix; and contacting the evacuated periodic structure with a biomaterial which interacts with the polymer matrix.
Clause 10. The method of clause 9, further comprising providing a second top substrate which adheres to top surfaces of the polymer matrix and applying mechanical force to the second top substrate while the bottom substrate remains stationary to change the profile of the evacuated periodic structure.
Clause 11. The method of clause 9, wherein the evacuated periodic structure includes a two-dimensional array of holes in a polymer matrix.
Clause 12. The method of clause 11, wherein applying the holographic exposure to the mixture comprises a first holographic exposure and a second holographic exposure which has a different orientation from the first holographic exposure.
Clause 13. The method of clause 11, wherein the evacuated periodic structure is configured to store biofluids for analysis in the holes.
Clause 14. The method of clause 11, wherein a material having a different composition to that of the polymer matrix is backfilled into the holes.
Clause 15. The method of clause 9, wherein the evacuated periodic structure includes a two-dimensional array of polymer elements surrounded by air.
Clause 16. The method of clause 9, wherein the polymer matrix preferentially attaches to proteins.
Clause 17. The method of clause 9, further comprising ashing the polymer matrix to remove weak polymer networks remaining.
Clause 18. The method of clause 9, further comprising depositing non-reactive material on the polymer matrix after evacuating the inert material.
Clause 19. The method of clause 18, wherein depositing the non-reactive material comprises an atomic layer deposition process.
Clause 20. The method of clause 9, further comprising backfilling the evacuated periodic structure with material which preferentially binds with some biological species and not others.
Clause 21. The method of clause 9, further comprising coating the evacuated periodic structure with a material layer that allows the evacuated periodic structure to more effectively store proteins.
Clause 22. The method of clause 9, further comprising curing the exposure mixture, wherein weak polymer networks remaining after curing act as binding points for proteins.
Clause 23. The method of clause 9, wherein the evacuated periodic structure is doped with at least one chemical that interacts with molecules of a test sample leading to changes in the material and/or optical properties of the evacuated periodic structure.
Clause 24. The method of clause 9, wherein the evacuated periodic structure is configured for use with light emitters to stimulate emission or scatter from molecules in a test sample contacting the evacuated periodic structure.
Clause 25. The biosensor of clause 9, wherein the evacuated periodic structure is configured to amplify emission or scatter from molecules in a test sample contacting the evacuated periodic structure.
Clause 26. The biosensor of clause 9, wherein the evacuated periodic structure is configured to direct emission or scatter from molecules in a test sample contacting the evacuated periodic structure to a detector.
Clause 27. The biosensor of clause 9, wherein the evacuated periodic structure is integrated with a waveguide used to convey and direct pump radiation onto a sample material.
Clause 28. The biosensor of clause 9, wherein the evacuated periodic structure is integrated with a waveguide used to convey emission or scatter from molecules in a test sample contacting the evacuated periodic structure to a detector.
Clause 29. The biosensor of clause 9, wherein the evacuated periodic structure forms a host structure for materials that react with molecules to be detected.
Clause 30. The biosensor of clause 9, wherein the evacuated periodic structure forms a host structure for materials to be analysed using material analysis by spectroscopic means.
Clause 31. The biosensor of clause 9, wherein the evacuated periodic structure forms a host structure for materials to be subjected to chemical processing.
Clause 32. The biosensor of clause 9, wherein the evacuated periodic structure includes gratings.
Clause 33. The biosensor of clause 9, wherein the evacuated periodic structure includes photonic crystals.
Clause 34. The biosensor of clause 9, wherein the evacuated periodic structure includes arrays of cylindrical cavities.
Clause 35. The biosensor of clause 9, wherein the evacuated periodic structure is doped with material providing at least one of electrical conductivity, electrically variable birefringence, and/or piezoelectric properties.
Clause 36. The biosensor of clause 9, wherein the evacuated periodic structure is responsive to at least one of thermal, electrical, magnetic, chemical, mechanical, and/or electromagnetic stimuli.
Clause 37. The biosensor of clause 9, wherein the evacuated periodic structure is backfilled with materials for interacting with molecules to be detected.
Clause 38. The biosensor of clause 9, wherein the evacuated periodic structure is formed from polymers doped with chemicals or polymers with intrinsic chemical properties.
Clause 39. The biosensor of clause 9, wherein the evacuated periodic structure is formed from polymers with intrinsic chemical properties for detecting specific molecules.
Clause 40. The biosensor of clause 9, wherein the evacuated periodic structure has index modulation, average index or birefringence changed by presence of molecules.
Clause 41. The biosensor of clause 9, wherein the evacuated periodic structure is fabricated using processes involving at least one selected from the group consisting of ink jet printing, holographic lithography, mask lithography, ashing, and/or thin film coating deposition.
Clause 42. The biosensor of clause 9, wherein the evacuated periodic structure is configured for detecting one selected from the group consisting of: gases, liquids, particulate phases, multiphase systems, or mixtures of components of more than one type of molecular structure.
Clause 43. The biosensor of clause 9, wherein the evacuated periodic structure is integrated with polymer electronics for detection, wireless communication.
Clause 44. The biosensor of clause 9, wherein the evacuated periodic structure is integrated in hybrid plastic/silicon electronics.
Clause 45. The biosensor of clause 9, wherein the evacuated periodic structure is incorporated into electromechanical devices.
Clause 46. The biosensor of clause 9, wherein the evacuated periodic structure is configured for use in one of visible, IR, millimeter wave, and/or microwave wavelength bands.
Clause 47. A waveguide device comprising: an optical substrate; a first grating with a first K-vector configured to couple light from an external source into a TIR path in the substrate; a second grating with a second K-vector; a third grating with a third K-vector; and a grating region formed by multiplexing a fourth grating with a K-vector identical to that of the second grating and a fifth grating with a K-vector identical to that of the third grating configured to provide a harmonic grating with an effective grating period different than that of the first grating, wherein at least a portion of the grating region extracts light out of the substrate towards an eyebox.
Clause 48. The waveguide device of clause 47, configured to provide first beam diffraction at the first grating, a second beam diffraction and a first beam expansion at the second or third grating, and a third diffraction and a second beam expansion in the grating region.
Clause 49. The waveguide device of clause 47, wherein light from the external source comprises image modulated light collimated over a field of view.
Clause 50. The waveguide device of clause 49, wherein a portion of the field of view is projected into the eyebox by a first diffraction at the first grating, a second diffraction and a first beam expansion at the second grating, and a third diffraction and a second beam expansion in the grating region, wherein a second portion of the field of view is projected into the eyebox by a first diffraction at the first grating, a second diffraction and a first beam expansion at the third grating, and a third diffraction and a second beam expansion in the grating region.
Clause 51. The waveguide device of clause 47, wherein the eyebox overlaps the grating region.
Clause 52. The waveguide device of clause 47, wherein K-vector closure exits between the first K-vector, the second K-vector and the third K-vector.
Clause 53. The waveguide device of clause 47, wherein said second grating and said third grating have K-vectors symmetrically disposed about the K-vector of said first grating.
Clause 54. The waveguide device of clause 47, wherein said fourth grating and said fifth grating have K-vectors symmetrically disposed about the K-vector of said first grating.
Clause 55. The waveguide device of clause 47, wherein each grating comprises one selected from the group consisting of a surface relief grating, a Bragg grating, or a switchable Bragg grating.
Clause 56. The waveguide device of clause 47, wherein the harmonic grating has a K-vector substantially parallel to the K-vector of the first grating in a waveguide plane.
Clause 57. The waveguide device of clause 47, wherein the harmonic grating has a grating period greater than that of the first grating.
Clause 58. The waveguide device of clause 47, wherein the harmonic grating has a grating period that is exactly two times that of the first grating.
Clause 59. The waveguide device of clause 47, wherein harmonic grating has a grating period smaller than that of the first grating.
Clause 60. The waveguide device of clause 47, wherein the grating region is formed by multiplexing orthogonal gratings having intersection nodes at corners of a repeating rectangle with a long dimension of the rectangle parallel to the K-vector of the harmonic grating.
Clause 61. The waveguide device of clause 47, wherein the grating region is formed by multiplexing orthogonal gratings having intersection nodes at corners of a repeating rectangle with a short dimension of the rectangle parallel to the K-vector of the harmonic grating.
Clause 62. The waveguide device of clause 47, wherein the grating region is formed using a master comprising spatially displaced gratings with orthogonal K-vectors.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A method for fabricating a diffractive structure, the method comprising:
providing a bottom substrate;
coating a mixture of an inert material and a monomer onto the bottom substrate;
providing a first top substrate to position the mixture between the bottom substrate and the first top substrate;
applying holographic exposure to the mixture to form an intermediate diffractive structure comprising a polymer matrix separated by inert material rich regions;
removing the first top substrate;
evacuating the inert material from the inert material rich regions leaving an evacuated diffractive structure where the inert material rich regions have been replaced with air;
providing a second top substrate which adheres to the top surfaces of the polymer matrix; and
applying mechanical force to the second top substrate while the bottom substrate remains stationary to change the profile of the evacuated diffractive structure.

2. The method of claim 1, wherein evacuating the inert material produces a two-dimensional array of holes within a polymer matrix and extending from the bottom substrate, wherein the holes are elongated in a direction orthogonal to the bottom substrate.

3. The method of claim 2, wherein applying holographic exposure to the mixture comprises a first holographic exposure and a second holographic exposure which has a different orientation from the first holographic exposure.

4. The method of claim 1, wherein evacuating the inert material results in a two-dimensional array of polymer elements in contact with the bottom substrate and surrounded by air, wherein the polymer elements are elongated in a direction orthogonal to the bottom substrate.

5. The method of claim 4, wherein applying holographic exposure to the mixture comprises a single holographic exposure.

6. The method of claim 1, wherein the diffractive structure is a surface relief grating.

7. The method of claim 1, wherein applying the mechanical force to the second top substrate comprises applying pressure to the evacuated diffractive structure along a direction orthogonal to the interface between the bottom substrate and the evacuated diffractive structure.

8. The method of claim 7, applying the mechanical force to the second top substrate comprises applying a shear force to the second top substrate along a direction parallel to the interface between the bottom substrate and the evacuated diffractive structure, wherein the position of the base of the diffractive structure remains fixed relative to the bottom substrate.

9. A method of forming a biosensor, the method comprising:
providing a bottom substrate;
coating a mixture of an inert material and a monomer onto the bottom substrate;
providing a first top substrate to position the mixture between the bottom substrate and the first top substrate;
applying holographic exposure to the mixture to form an intermediate periodic structure comprising a polymer matrix separated by inert material rich regions;
removing the first top substrate;
evacuating the inert material from the inert material rich regions leaving an evacuated periodic structure where the inert material rich regions have been replaced with air within the polymer matrix; and
contacting the evacuated periodic structure with a biomaterial which interacts with the polymer matrix.

10. The method of claim 9, further comprising providing a second top substrate which adheres to top surfaces of the polymer matrix and applying mechanical force to the second top substrate while the bottom substrate remains stationary to change the profile of the evacuated periodic structure.

11. The method of claim 9, wherein the evacuated periodic structure includes a two-dimensional array of holes in a polymer matrix; and wherein applying the holographic exposure to the mixture comprises a first holographic exposure and a second holographic exposure which has a different orientation from the first holographic exposure.

12. (canceled)

13. The method of claim 11, wherein the evacuated periodic structure is configured to store biofluids for analysis in the holes.

14. The method of claim 11, wherein a material having a different composition to that of the polymer matrix is backfilled into the holes.

15. The method of claim 9, wherein the evacuated periodic structure includes a two-dimensional array of polymer elements surrounded by air.

16. (canceled)

17. The method of claim 9, further comprising ashing the polymer matrix to remove weak polymer networks remaining.

18. (canceled)

19. (canceled)

20. The method of claim 9, further comprising backfilling the evacuated periodic structure with material which preferentially binds with some biological species and not others.

21. The method of claim 9, further comprising coating the evacuated periodic structure with a material layer that allows the evacuated periodic structure to more effectively store proteins.

22. (canceled)

23. The method of claim 9, wherein the evacuated periodic structure is doped with at least one chemical that interacts with molecules of a test sample leading to changes in the material and/or optical properties of the evacuated periodic structure.

24. The method of claim 9, wherein the evacuated periodic structure is configured for use with light emitters to stimulate emission or scatter from molecules in a test sample contacting the evacuated periodic structure.

25-41. (canceled)

43. The biosensor of claim 9, wherein the evacuated periodic structure is integrated with polymer electronics for detection, wireless communication.

44-62. (canceled)
